(19) United States
(12) Patent Application Publication
(10) Pub. No.: US 2025/0350830 A1
(43) Pub. Date: Nov. 13, 2025

(54) INFORMATION PROCESSING APPARATUS, IMAGE CAPTURING APPARATUS, CONTROL METHOD, AND RECORDING MEDIUM

(71) Applicant: CANON KABUSHIKI KAISHA, Tokyo (JP)

(72) Inventor: Kuniaki Sugitani, Kanagawa (JP)

(21) Appl. No.: 19/188,199

(22) Filed: Apr. 24, 2025

(30) Foreign Application Priority Data
May 7, 2024 (JP) 2024-075409

(51) Int. Cl. H04N 23/67

(52) U.S. Cl. CPC H04N 23/67

(57) ABSTRACT

An information processing apparatus determines a target parameter for use in focus adjustment when shooting a subject. The apparatus acquires information relating to a distribution of subject areas in a captured image view angle, acquires focus detection results of a plurality of focus detection areas provided for the captured image view angle, infers a range in a depth direction in which the subject exists, based on the information relating to the distribution of the subject areas and the focus detection results of the plurality of focus detection areas and determines the target parameter based on the inference range in the depth direction. The apparatus switches a method of determining the target parameter according to the range in the depth direction.

### BACKGROUND OF THE INVENTION

### Field of the Invention

The present invention relates to an information processing apparatus, an image capturing apparatus, a control method, and a recording medium, and relates particularly to a focus adjustment technology.

### Description of the Related Art

There is a technology that allows focus adjustment to focus on a subject based on defocus amounts and subject distances in predetermined focus detection areas of a captured image. In such a focus adjustment technology, when a subject is temporarily occluded by, for example, an object crossing between the subject and an image capturing apparatus, focus adjustment can be made to focus on the object (occluding object) in the foreground. Japanese Patent Laid-Open No. 2022-137760 discloses that focus adjustment is performed by excluding areas indicating near-side subject distances by a predetermined amount relative to the average of the subject distances corresponding to a plurality of focus detection areas, from the focus target.

Meanwhile, especially in scenes where the distance range in a depth direction over which a subject is distributed changes from moment to moment, such as a scene where the subject is moving, it can be difficult to perform focus adjustment of keeping a specific part (e.g., the face area) of the subject in focus.

For example, FIGS. 7A to 7G show the rotation (spin) of a subject (athlete) in a figure skating competition scene. Each of FIGS. 7A to 7G is an image of the subject captured at a different time, with the image capture timing elapsing in order of FIGS. 7A, 7B, 7C, 7D, 7E, 7F, and 7G. In the shown example, a head 701 of the subject is occluded by a left arm 702 in FIGS. 7C to 7E, and the mode of occluding at each image capture timing is different. It is assumed that in such a scene, a plurality of focus detection areas are set in the detected face area in order to keep the face area of the subject in focus. In this case, since the head 701 and the left arm 702 belong to the same subject, changes in defocus amount in the focus detection areas distributed at the boundary between the head 701 and the left arm 702 can be regarded as being continuous. In other words, in contrast to an occluding object such as an object separate from the subject and present on the near side, the left arm 702 can be regarded as a part of the subject that is integral with the head 701. Accordingly, even if the derived average of the subject distances of the plurality of focus detection areas including the left arm 702 is adopted as in Japanese Patent Laid-Open No. 2022-137760, there is a possibility that focus adjustment of keeping the face area of the subject suitably in focus cannot be realized.

### SUMMARY OF THE INVENTION

The present invention has been made in view of the above-described problem, and provides an information processing apparatus, an image capturing apparatus, a control method, and a recording medium that can perform stable focus adjustment irrespective of changes in the state of a subject.

The present invention in its first aspect provides an information processing apparatus that determines a target parameter for use in focus adjustment when shooting a subject, comprising: at least one processor and/or circuit; and at least one memory storing a computer program, which causes the at least one processor and/or circuit to function as following units: a first acquisition unit configured to acquire information relating to a distribution of subject areas in a captured image view angle; a second acquisition unit configured to acquire focus detection results of a plurality of focus detection areas provided for the captured image view angle; an inference unit configured to infer a range in a depth direction in which the subject exists, based on the information relating to the distribution of the subject areas and the focus detection results of the plurality of focus detection areas; and a determination unit configured to determine the target parameter based on the inference range in the depth direction, wherein the determination unit switches a method of determining the target parameter according to the range in the depth direction.

The present invention in its second aspect provides an image capturing apparatus comprising: an imaging optical system including a focus lens; an image capturing unit; a control unit configured to control the imaging optical system; and the information processing apparatus of the first aspect, wherein the control unit drives the focus lens based on the target parameter determined by the determination unit, and the image capturing unit shoots an image for recording on the condition that the focus lens is driven based on the target parameter.

The present invention in its third aspect provides a control method of an information processing apparatus determining a target parameter for use in focus adjustment when shooting a subject, the method comprising: acquiring information relating to a distribution of subject areas in a captured image view angle; acquiring focus detection results of a plurality of focus detection areas provided for the captured image view angle; inferring a range in a depth direction in which the subject exists, based on the information relating to the distribution of the subject areas and the focus detection results of the plurality of focus detection areas; and determining the target parameter based on the inference range in the depth direction, wherein in the determining, a method of determining the target parameter is switched according to the range in the depth direction.

The present invention in its fourth aspect provides a computer-readable recording medium having recorded thereon a program for causing a computer to function as the units of the information processing apparatus of the first aspect.

Further features of the present invention will become apparent from the following description of exemplary embodiments (with reference to the attached drawings).

### BRIEF DESCRIPTION OF THE DRAWINGS

FIG. 1 is a block diagram showing an example of a hardware configuration of an image capturing apparatus 10 according to embodiments and modifications of the present invention.

FIG. 2 is a diagram illustrating a detailed configuration of an image sensor 122 according to the embodiments and modifications of the present invention.

FIGS. 3A and 3B are respectively a plan view and a cross-sectional view of a pixel of the image sensor 122 according to the embodiments and modifications of the present invention.

FIG. 4 is a diagram illustrating the correspondence relationship between a pixel structure and a pupil surface according to the embodiments and modifications of the present invention.

FIG. 5 is a diagram illustrating the correspondence relationship between the pixel structure and pupil division according to the embodiments and modifications of the present invention.

FIG. 6 is a diagram illustrating the relationship between a defocus amount and an image shift amount according to the embodiments and modifications of the present invention.

FIGS. 7A, 7B, 7C, 7D, 7E, 7F, and 7G are diagrams showing examples of captured image of a figure skating competition scene.

FIG. 8 is a diagram illustrating focus detection areas according to the embodiments and modifications of the present invention.

FIG. 9 is a block diagram showing an example of a functional configuration of a subject detection unit 130 according to the embodiments and modifications of the present invention.

FIG. 10 is a block diagram showing an example of a functional configuration of an inferrer 132 according to the embodiments and modifications of the present invention.

FIGS. 11A and 11B are diagrams each illustrating a subject map according to the embodiments and modifications of the present invention.

FIG. 12 is a block diagram showing an example of a training device 1200 that constructs a learned model.

FIG. 13 is a diagram illustrating extracted defocus amounts according to the embodiments and modifications of the present invention.

FIG. 14 is a diagram showing an example of time transition of the width of an inference range according to Embodiment 1 of the present invention.

FIG. 15 is a flowchart showing an example of shooting processing that is executed by a camera body 120 according to the embodiments and modifications of the present invention.

FIG. 16 is a flowchart showing an example of control processing that is executed by the camera body 120 according to Embodiment 1.

FIG. 17 is a diagram showing an example of time transition of the amount of temporal variation in the width of an inference range according to Embodiment 2 of the present invention.

FIG. 18 is a flowchart showing an example of control processing that is executed by the camera body 120 according to Embodiment 2.

FIG. 19 is a diagram showing an example of a temporal variation in a focus position based on an inference range according to Embodiment 3 of the present invention.

FIG. 20 is a flowchart showing an example of control processing that is executed by the camera body 120 according to Embodiment 3.

### DESCRIPTION OF THE EMBODIMENTS

### Embodiment 1

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

An embodiment described below will describe an example in which the present invention is applied to an image capturing apparatus serving as an example of an information processing device. The image capturing apparatus performs focus adjustment by driving a focus lens according to the focus state of a subject and shoots an image for recording. However, the present invention is applicable to any device capable of determining target parameters used as a basis of focus adjustment when shooting a subject.

### Hardware Configuration of Image Capturing Apparatus 10

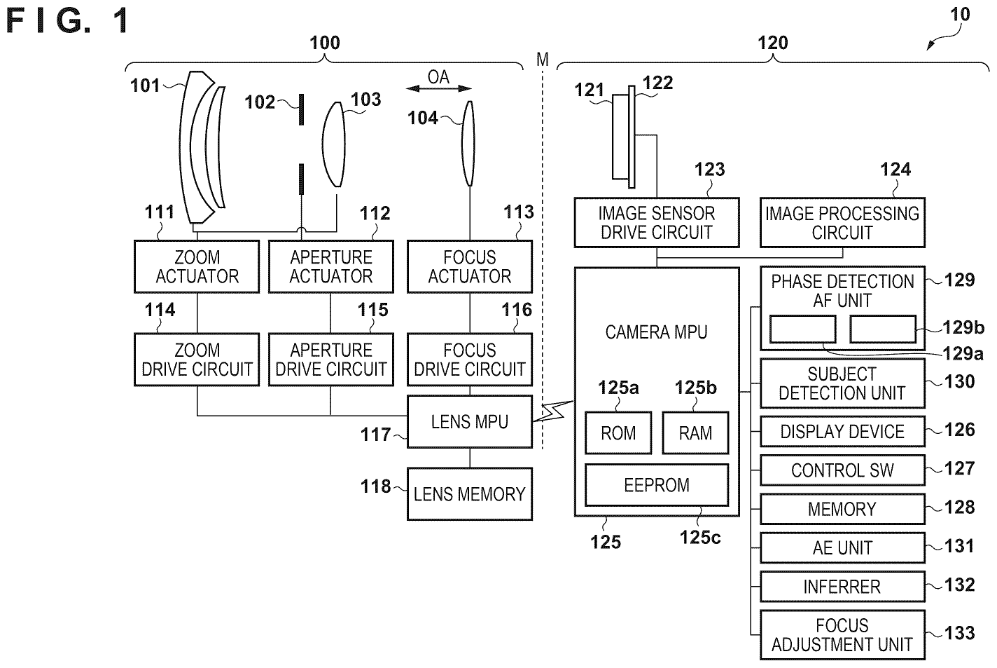

FIG. 1 is a block diagram showing an example of a hardware configuration of an image capturing apparatus 10 according to the present embodiment. The image capturing apparatus 10 shown in FIG. 1 is a lens-interchangeable digital single-lens camera. The image capturing apparatus 10 is a camera system that includes a lens unit 100 (interchangeable lens) and a camera body 120. The lens unit 100 is detachably attached to the camera body 120 via a mount M indicated by a dashed line in FIG. 1.

Note that although, in the example of FIG. 1, the image capturing apparatus 10 is described as being configured as a lens-interchangeable system, it is to be understood that the present invention can be realized even with an image capturing apparatus in which the lens unit 100 and the camera body 120 are formed in one piece. In addition, an image capturing apparatus such as a video camera can also be included in the image capturing apparatus 10.

The lens unit 100 is a shooting lens (imaging optical system) that forms a subject image on a later-described image sensor 122 of the camera body 120. In the shown example, the lens unit 100 includes a first lens group 101, an aperture 102, a second lens group 103, a focus lens group (hereinafter referred to simply as “focus lens”) 104, and a drive/control system.

The first lens group 101 is located at the leading end of the lens unit 100 and is held so as to be movable back and forth in an optical axis direction OA. The aperture 102 adjusts the opening size thereof to adjust the amount of light during shooting, and also functions as a shutter for adjusting the exposure time during still image shooting. The aperture 102 and the second lens group 103 are movable together in the optical axis direction OA, and realize the zoom function in conjunction with the back and forth movement of the first lens group 101. The focus lens 104 is movable in the optical axis direction OA, and changes the subject distance (focal distance) at which the lens unit 100 is focused according to the position thereof. In other words, by controlling the position of the focus lens 104 in the optical axis direction OA, it is possible to realize focus adjustment (focus control) of adjusting the focal distance of the lens unit 100.

In the shown example, the drive/control system of the lens unit 100 includes actuators and drive circuits that drive mainly the three types of components, namely, the first and second lens groups 101 and 103, the aperture 102, and the focus lens 104, individually. A zoom drive circuit 114 drives the first lens group 101 and the second lens group 103 in the optical axis direction OA using a zoom actuator 111 to control the captured image view angle of the imaging optical system of the lens unit 100 (to realize zoom operation). An aperture drive circuit 115 drives the aperture 102 using an aperture actuator 112 to control the opening size and opening/closing operation of the aperture 102. A focus drive circuit 116 drives the focus lens 104 in the optical axis direction OA using a focus actuator 113 to control the focal distance of the imaging optical system of the lens unit 100 (to perform focus control). The focus drive circuit 116 also functions as a position detection unit that detects the current position (lens position) of the focus lens 104 using the focus actuator 113.

A lens MPU (processor) 117 performs all calculations and controls related to the lens unit 100 to control the zoom drive circuit 114, the aperture drive circuit 115, and the focus drive circuit 116. The lens MPU 117 connects to a camera MPU 125 via the mount M to transmit and receive commands and data. For example, the lens MPU 117 detects the position of the focus lens 104 and gives a notification of lens position information in response to a request from the camera MPU 125. Examples of the lens position information include information regarding the position of the focus lens 104 in the optical axis direction OA, the position and diameter of an exit pupil in the optical axis direction OA when the imaging optical system is not moving, and the position and diameter, in the optical axis direction OA, of a lens frame that limits the light flux of the exit pupil. The lens MPU 117 also controls the zoom drive circuit 114, the aperture drive circuit 115, and the focus drive circuit 116 in response to a request from the camera MPU 125. A lens memory 118 stores optical information necessary for automatic focus adjustment (AF control). The camera MPU 125 controls the operation of the lens unit 100 by reading programs stored in the lens memory 118 or a built-in nonvolatile memory, expanding them into a not-shown volatile memory, and executing them, for example.

The camera body 120 includes an optical low pass filter 121, the image sensor 122, and a drive/control system. The optical low pass filter 121 and the image sensor 122 function as image capturing units that photoelectrically convert a subject image (optical image) formed through the lens unit 100 and output image data. In the present embodiment, the image sensor 122 photoelectrically converts a subject image formed through the imaging optical system and outputs a captured image signal and a focus detection signal as image data. In the following description, the first lens group 101, the aperture 102, the second lens group 103, the focus lens 104, and the optical low pass filter 121 may be referred to as the “imaging optical system”.

The optical low pass filter 121 reduces the occurrence of false colors and moire in a captured image. The image sensor 122 is constituted by, for example, a CMOS image sensor and peripheral circuits thereof. On the image sensor 122, photoelectric conversion elements in an array of m pixels in the lateral direction (horizontal direction) and n pixels in vertical direction (perpendicular direction) are arranged (m and n are integers of two or more). The image sensor 122 of the present embodiment also functions as a focus detection element, and includes a pupil division pixel that has the pupil dividing function and can perform focus detection of a phase difference detection method (phase detection AF) using image data (image signals).

In the shown example, the drive/control system of the camera body 120 includes various types of hardware. In the example of FIG. 1, the pieces of hardware are provided separately as different circuits or processors, but at least some of the pieces may be realized by the camera MPU 125 or other device executing a program for the corresponding processing.

An image sensor drive circuit 123 controls the operation of the image sensor 122. The image sensor drive circuit 123 performs A/D conversion on the image signals (image data) output from the image sensor 122 and transmits the resultant to the camera MPU 125. An image processing circuit 124 performs typical image processing that is performed in digital cameras, such as y conversion, color interpolation processing, and compression coding processing, on the image signals output from the image sensor 122. The image processing circuit 124 also generates signals for phase detection AF, AE, and subject detection.

Note that the present embodiment is described on the assumption that the image processing circuit 124 generates signals for phase detection AF, AE, and subject detection, but the implementation of the present invention is not limited to this. For example, a signal for AE and a signal for subject detection may be generated as a common signal. Also, the combination of signals that serve as a common signal is not limited to this.

The camera MPU 125 (processor, control device) performs all operations and controls related to the camera body 120. That is, the camera MPU 125 controls the image sensor drive circuit 123, the image processing circuit 124, a display 126, an operation switch group 127, a memory 128, a phase detection AF unit 129, a subject detection unit 130, an AE unit 131, an inferrer 132, and a focus adjustment unit 133. The camera MPU 125 is connected to the lens MPU 117 via a signal line of the mount M to transmit and receive commands and data. The camera MPU 125 issues, to the lens MPU 117, a request to acquire the lens position and a request to drive the lens at a predetermined drive amount. The camera MPU 125 also issues a request for acquisition of optical information specific to the lens unit 100, or the like, and transmits the request to the lens MPU 117.

A ROM 125a storing a program to control the operation of the camera body 120, a RAM 125b (camera memory) storing variables, and an EEPROM 125c storing various parameters are built in the camera MPU 125. The camera MPU 125 reads the program stored in the ROM 125a, expands it in the RAM 125b, and executes it to perform processing such as focus detection processing. For example, in the focus detection processing, known correlation calculation processing is executed using a pair of image signals obtained by photoelectrically converting optical images formed by light fluxes having passed through mutually different pupil regions (pupil subregions) of the imaging optical system.

The display 126 is a display device such as an LCD. The display 126 displays information regarding the shooting mode of the image capturing apparatus 10, a preview image before shooting and an image for checking after shooting, an image showing in-focus state during focus detection, and the like.

The operation switch group 127 is a group of various types of user input interfaces included in the camera body 120. The operation switch group 127 can include, for example, a power switch, a release (shooting trigger) switch, a zoom operation switch, and a shooting mode selection switch, and the like.

The memory 128 is, for example, a removable flash memory (device) that stores images for recording obtained by shooting.

The phase detection AF unit 129 performs focus detection processing of the phase difference detection method, based on phase detection AF signals (focus detection signals) obtained from the image sensor 122 and the image processing circuit 124. More specifically, the image processing circuit 124 generates a pair of image data pieces formed by light fluxes having passed through a pair of pupil regions of the imaging optical system as a focus detection signal, and the phase detection AF unit 129 derives a focus shift amount (defocus amount) based on the image shift amount between the image data pieces. Thus, the phase detection AF unit 129 of the present embodiment is configured to be able to perform phase detection AF (image sensing surface phase detection AF) based on the output of the image sensor 122, without using a dedicated AF sensor. Although details will be described later, in the image capturing apparatus 10 of the present embodiment, a plurality of focus detection areas are set for the captured image view angle, and the image processing circuit 124 outputs information regarding the defocus amounts (focus detection results) derived for the respective areas as focus detection information.

The subject detection unit 130 performs subject detection processing for detecting a subject of a predetermined type that is captured in the captured image view angle on the signal for subject detection (captured image signal, image signal, or captured image) generated by the image processing circuit 124. With the subject detection processing, it is possible to acquire, for example, information regarding the type and states of the subject, and the position and size of an area (detected subject area) occupied by each part of the subject in the captured image view angle. In other words, the subject detection unit 130 acquires information regarding the distribution of the subject areas in the captured image view angle (hereinafter referred to as “subject detection information”).

The AE unit 131 uses the signal for AE obtained from the image sensor 122 and the image processing circuit 124 to perform photometry of the subject and perform exposure adjustment processing for setting appropriate shooting conditions based on the result of the photometry. Specifically, the AE unit 131 uses the signal for AE to perform photometry and derive the amount of exposure of the subject at the currently set aperture value, shutter speed, and ISO sensitivity. The AE unit 131 then derives the appropriate aperture value, shutter speed, and ISO sensitivity to be set during shooting from the difference between the derived amount of exposure and the predetermined optimal amount of exposure, and applies the derived results as new shooting conditions, thereby performing exposure adjustment.

The inferrer 132 infers the range in the depth direction where the subject captured within the captured image view angle exists, using the captured image signal, subject detection information, and focus detection information that were used for subject detection as inputs. In the present embodiment, it is assumed that the inferrer 132 infers the range in the depth direction (optical axis direction) where the subject exits, as the value range of defocus amounts. In other words, the inferrer 132 can infer in which distance range in the depth direction the subject captured by a captured image signal is distributed, as the value range of defocus amounts in the captured image signal.

The focus adjustment unit 133 determines the position of the focus lens 104 that should be set when shooting the subject. By performing control such that the focus lens 104 is moved to the position determined by the focus adjustment unit 133, focus adjustment for shooting is realized. Although details will be described later, when determining the position of the focus lens 104, the focus adjustment unit 133 refers to the focus detection information output by the phase detection AF unit 129 and the information on the value range of defocus amounts inferred by the inferrer 132.

Thus, the image capturing apparatus 10 of the present embodiment is configured to be able to execute phase detection AF, photometry (exposure adjustment), and subject detection in combination.

### Configuration of Image Sensor 122

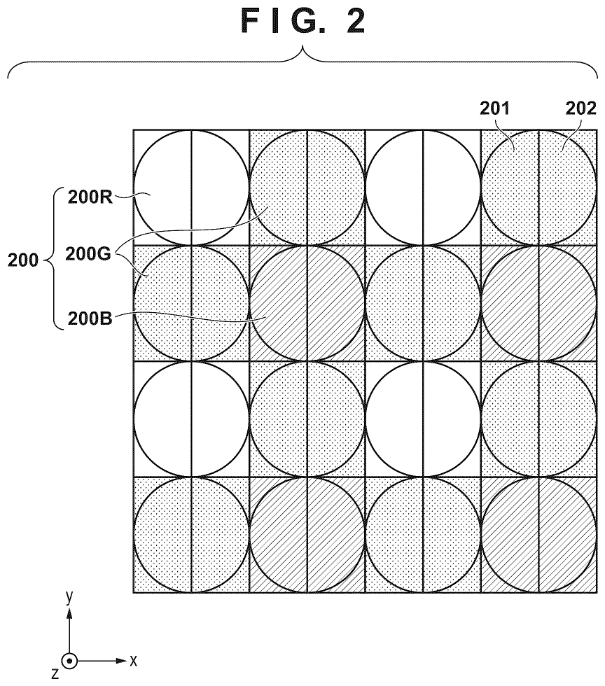

In the following, a configuration of the image sensor 122 of the present embodiment will be further described in detail. FIG. 2 is a schematic diagram showing an example of an array of image pixels (and focus detection pixels) of the image sensor 122. In FIG. 2, a pixel (image pixel) array of 4 columns and 4 rows of a two-dimensional CMOS sensor (image sensor 122) is shown.

In the present embodiment, color filters of the same pattern in units of pixel array (pixel group 200) of 2 columns and 2 rows are applied to the image sensor 122. In the shown example, the color filters are arranged so that an upper left pixel 200R in the pixel group 200 has a higher spectral sensitivity of red (R), upper right and lower left pixels 200G have a higher spectral sensitivity of green (G), and a lower right pixel 200B has a higher spectral sensitivity of blue (B). As shown in the figure, one image pixel is divided in the horizontal direction into two focus detection pixels (first focus detection pixel 201 and second focus detection pixel 202), so the focus detection pixels are arranged in a pixel array of 8 column by 4 rows.

It is assumed that the pattern of pixels of 4 columns and 4 rows (focus detection pixels of 8 columns and 4 rows) shown in FIG. 2 is repeated on the surface of the image sensor 122. In one mode, the image sensor 122 can have an image pixel period P of 4 μm and a pixel count N of approximately 20.75 million pixels, obtained by multiplying 5575 horizontal columns and 3725 vertical rows. In this case, the image sensor 122 can have a column direction period PAF of 2 μm and a focus detection pixel count NAF of approximately 41.50 million pixels, obtained by multiplying 11150 horizontal columns and 3725 vertical rows.

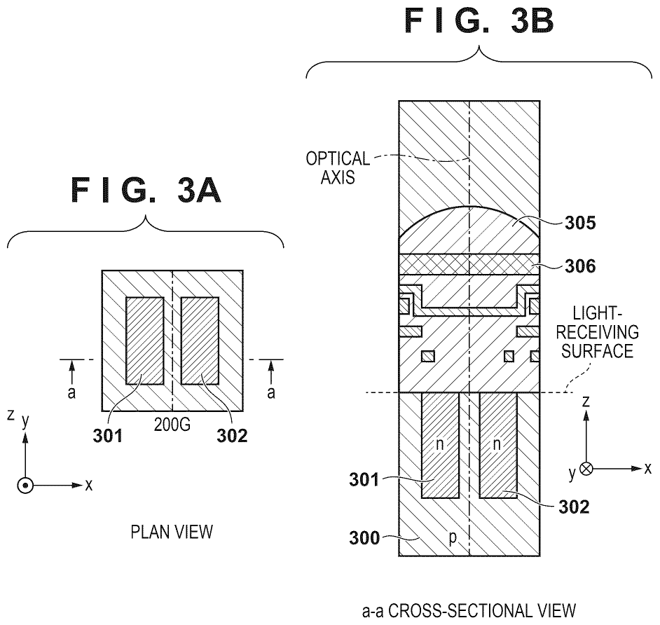

FIG. 3A is a plan view of one pixel 200G of the image sensor 122 viewed from the light-receiving side (+z side) of the image sensor 122, and FIG. 3B is a cross-sectional view taken along a line a-a in FIG. 3A viewed from the −y side.

As shown in FIG. 3B, one pixel 200G has a microlens 305 for collecting incident light on the light-receiving side, and includes a photoelectric conversion portion 301 and a photoelectric conversion portion 302, which are NH-divided (two divisions) in the x-direction and NV-divided (one division) in the y-direction. The photoelectric conversion portion 301 and the photoelectric conversion portion 302 respectively correspond to the first focus detection pixel 201 and the second focus detection pixel 202.

The photoelectric conversion portion 301 and the photoelectric conversion portion 302 may be pin-structure photodiodes with an intrinsic layer interposed between a p-type layer 300 and an n-type layer, or may be a pn-junction photodiodes without the intrinsic layer, if necessary. In each pixel, a color filter 306 is formed between the microlens 305, and the photoelectric conversion portions 301 and 302. Also, if necessary, the spectral transmittance of the color filter may be changed for each sub-pixel, or the color filter may be omitted.

Light incident on the pixel 200G shown in FIG. 3B is collected by the microlens 305, subjected to spectroscopy by the color filter 306, and then received by the photoelectric conversion portions 301 and 302. In the photoelectric conversion portion 301 and the photoelectric conversion portion 302, electrons and holes are paired according to the amount of received light, and after the pairs are separated by a depletion layer, the negatively charged electrons are accumulated in the n-type layer, whereas the holes are discharged to the outside of the image sensor via the p-type layer 300 connected to a constant voltage source (not shown). The electrons accumulated in the n-type layers of the photoelectric conversion portions 301 and 302 are transferred to a capacitance portion (FD) through a transfer gate and are converted into voltage signals.

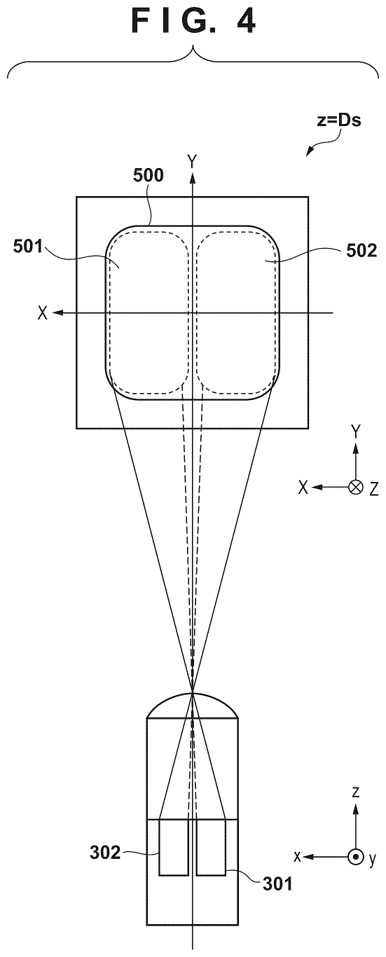

FIG. 4 is a schematic diagram showing the correspondence relationship between the pixel structure and pupil division of the present embodiment shown in FIGS. 3A and 3B. In FIG. 4, a cross-sectional view taken along the line a-a of the pixel structure in FIG. 3A viewed from +y side and a pupil surface (pupil distance DS) of the image sensor 122 are shown. In FIG. 4, the x-axis and y-axis of the cross-sectional view are inverted with respect to FIG. 3B so as to correspond to the coordinate axes of the pupil surface of the image sensor 122.

In FIG. 4, a first pupil subregion 501 has a substantially conjugate relation with a light-receiving surface of the photoelectric conversion portion 301 whose center of gravity is eccentric in the-x direction due to the microlens, and represents a pupil region 500 that can receive light with the first focus detection pixel 201. The center of gravity of the first pupil subregion 501 is eccentric in the +X direction on the pupil surface. In FIG. 4, a second pupil subregion 502 of the second focus detection pixel 202 has a substantially conjugate relation with a light-receiving surface of the photoelectric conversion portion 302 whose center of gravity is eccentric in the +x direction due to the microlens, and represents the pupil region 500 that can receive light with the second focus detection pixel 202. The center of gravity of the second pupil subregion 502 of the second focus detection pixel 202 is eccentric in the-X direction on the pupil surface. Also, in FIG. 4, the pupil region 500 is a pupil region that can receive light with the entire pixel 200G that includes a combination of the photoelectric conversion portions 301 and 302 (first and second focus detection pixels 201 and 202).

The image sensing surface phase detection AF is affected by diffraction since the pupil division is performed using the microlenses of the image sensor 122. In FIG. 4, the pupil distance to the pupil surface of the image sensor 122 is several 10 mm, whereas the diameter of the microlens is several micrometers. Therefore, the aperture value of the microlens is tens of thousands, resulting in diffraction blur at the level of several 10 mm. Accordingly, images on the light-receiving surfaces of the photoelectric conversion portions do not serve as distinct pupil regions or pupil subregions, but have photosensitive characteristics (incident angle distribution of photosensitivity).

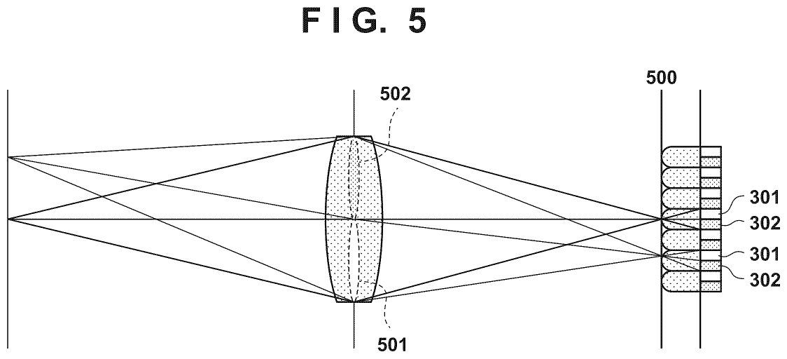

FIG. 5 is a schematic diagram showing the correspondence relationship between the image sensor 122 and pupil division. The light fluxes having passed through the different pupil subregions, namely, the first pupil subregion 501 and the second pupil subregion 502, enter the pixels of the image sensor at different angles and received by the first focus detection pixels 201 and the second focus detection pixels 202, which are divisions obtained by 2 by 1 division. Note that, in the present embodiment, the pupil region is described as being divided into two divisions in the horizontal direction as described above, but the direction of pupil division is not limited to this and can also include the vertical direction.

In the image sensor 122 of the present embodiment, a plurality of image pixels each including the first focus detection pixel 201 and the second focus detection pixel 202 are arrayed. The first focus detection pixel 201 receives a light flux having passed through the first pupil subregion 501 of the imaging optical system. Also, the second focus detection pixel 202 receives a light flux having passed through the second pupil subregion 502, which is different from the first pupil subregion 501, of the imaging optical system. The image pixel receives a light flux having passed through a pupil region that includes a combination of the first pupil subregion 501 and the second pupil subregion 502 of the imaging optical system.

In the image sensor 122 of the present embodiment, each image pixel is described as consisting of the first focus detection pixel 201 and the second focus detection pixel 202. However, a configuration is also possible in which the image pixel, the first focus detection pixel 201, and the second focus detection pixel 202 are separate pixels, and the first focus detection pixel 201 and the second focus detection pixel 202 are partially arranged in part of the image pixel array.

In the present embodiment, a first focus signal is generated by collecting light-receiving signals of the first focus detection pixels 201 of the pixels of the image sensor 122, a second focus signal is generated by collecting light-receiving signals of the second focus detection pixels 202 of the pixels, and focus detection is performed using these signals. For each pixel of the image sensor 122, a signal of the first focus detection pixel 201 and a signal of the second focus detection pixel 202 are summed to generate a captured image signal (captured image) with a resolution of effective pixel count of N. Note that the method of generating each signal is not limited to the method described in the present embodiment, and another method may also be used, for example, by generating the second focus signal from the difference between the captured image signal and the first focus signal.

### Relationship Between Defocus Amount and Image Shift Amount

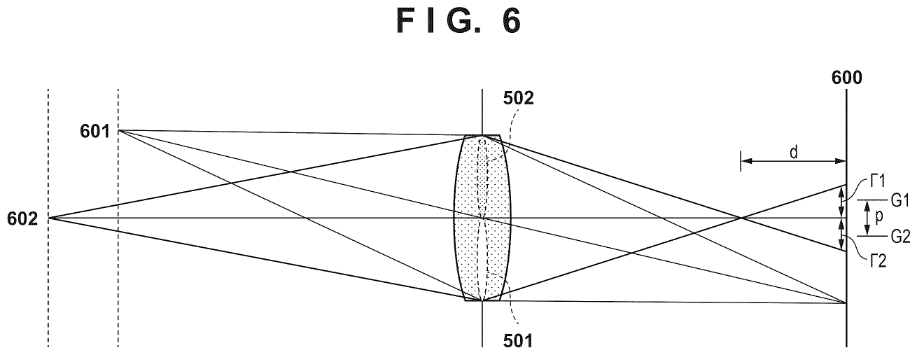

The following will describe the relationship between the image shift amount in the first and second focus detection signals acquired by the image sensor 122 and the defocus amount of a subject, with reference to FIG. 6. In FIG. 6, the image sensor 122 (not shown) is placed on an image sensing surface 600, and as in FIGS. 4 and 5, the pupil surface of the image sensor 122 is divided into two divisions, namely, the first pupil subregion 501 and the second pupil subregion 502. A defocus amount d is the distance from the image formation position of a subject to the image sensing surface, with the magnitude of the distance being defined as |d| and the defocus amount d in a front focus state where the image formation position of a subject is on the subject side relative to the image sensing surface being defined with a negative sign (d<0). The defocus amount d in a rear focus state where the image formation position of a subject is on the opposite side of the subject relative to the image sensing surface is defined with a positive sign (d>0). The defocus amount d in an in-focus state where the image formation position of a subject is on the image sensing surface (in-focus position) is defined as d=0. In FIG. 6, it is assumed that a subject 601 is a subject in the in-focus state (d=0) and a subject 602 is a subject in the front focus state (d<0). The front focus state (d<0) and the rear focus state (d>0) may be referred to collectively as a defocus state (|d|>0).

In the front focus state (d<0), the light flux from the subject 602 that has passed through the first pupil subregion 501 (second pupil subregion 502), once collected, spreads out over a width Γ1 (Γ2) centered at a gravity center position G1 (G2) of the light flux and forms a blurred image on the image sensing surface 600. The blurred image is received by the first focus detection pixel 201 (second focus detection pixel 202), which constitutes each pixel arrayed on the image sensor, and is output as the first focus detection signal (second focus detection signal). Therefore, the first focus detection signal (second focus detection signal) records a subject image in which the subject 602 is blurred in the width Γ1 (Γ2), at the gravity center position G1 (G2) on the image sensing surface 600. The blurring width Γ1 (Γ2) of the subject image increases substantially proportionally with an increase in the magnitude (|d|) of the defocus amount d. Similarly, a magnitude |p| of an image shift amount p (=difference between the gravity center positions G1−G2) of the subject images between the first and second focus detection signals also increases substantially proportionally with an increase in the magnitude (|d|) of the defocus amount d. In the rear focus state (d>0), the direction of image shift of the subject image between the first and second focus detection signals is opposite with respect to the front focus state, but shows the same tendency.

### Generation of Focus Detection Result

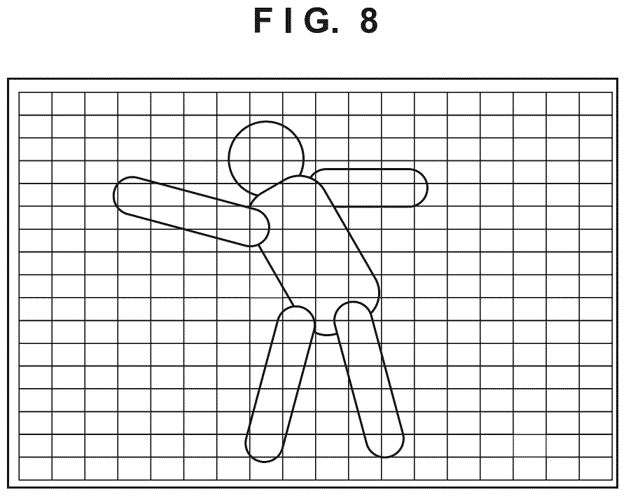

Since the signal for focus detection can be obtained by the image sensor 122 in this way, the phase detection AF unit 129 generates information for focus adjustment based on this signal. In the present embodiment, as shown in FIG. 8, a plurality of focus detection areas are set to cover the entire captured image view angle. In the shown example, the focus detection areas are set in a grid of 18 columns in the horizontal direction of the captured image view angle and 17 rows in the vertical direction. The phase detection AF unit 129 derives the defocus amount for each of these focus detection areas and generates a two-dimensional information (defocus map) in which the defocus amounts are stored in association with the arrangement of the focus detection areas. That is, when the focus detection areas are distributed as shown in FIG. 8, a defocus map in an array of 18 columns and 17 rows is generated as focus detection results. Each pixel in the defocus map indicates the defocus amount of the corresponding focus detection area of the focus detection signal.

The phase detection AF unit 129 also derives the confidence level indicating the evaluated confidence of the derived defocus amount. Typically, the more the amount of signals included in the spatial frequency band to be evaluated are, the more accurate the correlation calculation can be performed when deriving the defocus amount. For example, with signals having a large contrast or a large number of high-frequency components, more accurate defocus amounts can be derived.

In the present embodiment, the phase detection AF unit 129 derives the confidence level for each focus detection area based on the signal amounts of the two types of focus detection signals for use in focus detection of the focus detection areas and their correlation values. For example, the phase detection AF unit 129 derives a higher value as the confidence level the larger the amount of signals is. As the correlation value, the degree of change in correlation amount at the position with the highest correlation in the correlation calculation, the absolute sum of the differences between the signal to be subjected to focus detection and adjacent signals, or the like can be used. The larger the degree of change in correlation amount is and the larger the absolute sum is, the more accurate defocus amount can be derived, so the phase detection AF unit 129 derives a high value as the confidence level.

The phase detection AF unit 129 derives the confidence level in three level-values (low confidence “0”, medium confidence “1”, and high confidence “2”), for example. The phase detection AF unit 129 also derives, similar to the defocus map, two-dimensional information (confidence map) in which the confidence levels derived for the respective focus detection areas are stored in association with the arrangement of the focus detection areas. That is, the confidence map is configured in an array of 18 columns and 17 rows, similar to the defocus map.

### Functional Configuration of Subject Detection Unit 130

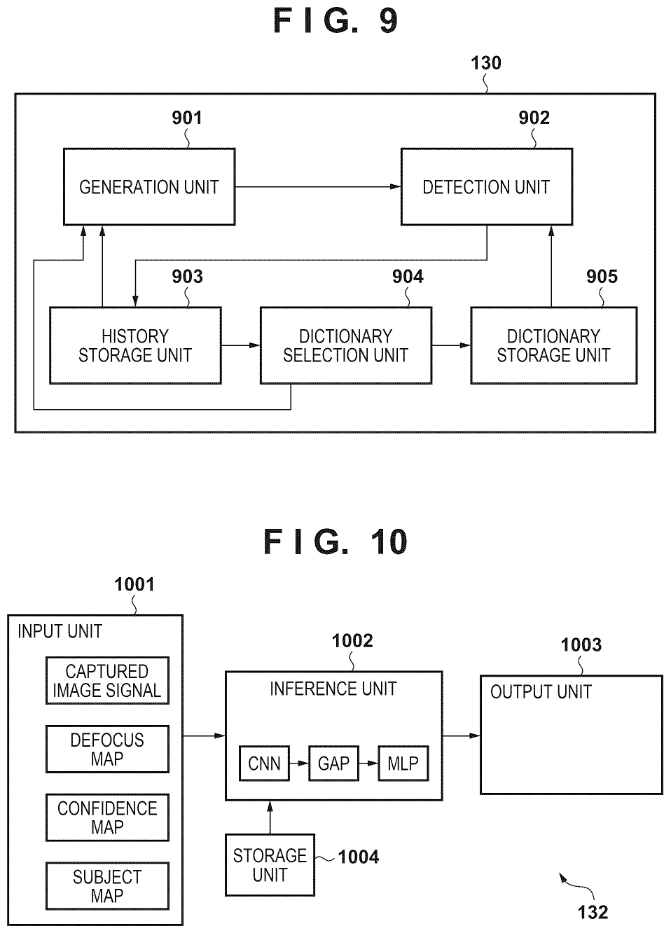

Next, an example of a functional configuration of the subject detection unit 130 of the embodiment will be described with reference to the block diagram of FIG. 9.

As described above, the subject detection unit 130 executes subject detection processing on an image signal (signal for subject detection) to generate subject detection information. The subject detection information includes information indicating which area of a part of the subject is distributed in which area within the captured image view angle (information regarding the position and size of the areas). Here, there are various methods for recognizing, for an image signal, a subject captured in the captured image view angle and identifying the part of the subject. As one mode of such a method, the subject detection unit 130 of the present embodiment adopts a method of using dictionary data in which a feature of each part of a subject of a predetermined type is registered and estimating the area in which the part indicating the corresponding feature would be distributed from the input image signal.

The dictionary data used to detect a subject area is stored in a dictionary storage unit 905. The subject detection unit 130 of the present embodiment is configured to be able to detect, for example, multiple types of subjects such as persons, vehicles, and animals, and dictionary data is provided for each of them. Since the subject detection unit 130 further detects, for each type of subject, positions at which the parts constituting the subject are distributed, dictionary data is also provided for each of the parts. Accordingly, the dictionary storage unit 905 stores, for each type of detectable subject, dictionary data for detecting the area in which the subject is distributed from the image signal input to the subject detection unit 130 and dictionary data for detecting the areas of the parts constituting the subject.

Here, basically, the area of a part constituting a subject is a portion of the area of the subject, so in the following description, the area of a part is referred to as a “local area”, whereas the area of the subject is referred to as the “whole area”. That is, the dictionary data stored in the dictionary storage unit 905 includes dictionary data for the whole area and dictionary data for local areas.

Note that although “whole area” is used in the present specification as a phrase opposite to “local area”, the detection of a subject by the subject detection unit 130 is not necessarily limited to the detection of an area that captures the whole subject. Detection of a subject can vary depending on the registration mode of a feature of the subject such as, for example, the upper body of a person, the body of an airplane, and the lead vehicle of a train. In contrast, detection of a part of a subject differs in that it is to detect an area that is much smaller than the area of such a subject.

The dictionary data stored in the dictionary storage unit 905 is used when the corresponding subject area is detected by a later-described detection unit 902. Which dictionary data is used to detect the subject area is selected by a dictionary selection unit 904. In the subject detection unit 130 of the present embodiment, the dictionary storage unit 905 switches between multiple dictionary data for an input image signal, in order to detect the whole area and a local area of a predetermined subject.

Dictionary data may be selected, for example, based on the user's input of selection of a subject type or on the history of detection results. In the subject detection unit 130 of the present embodiment, information regarding the results of detection performed by the detection unit 902 on an image signal are stored in a history storage unit 903. The information on detection results may include, for example, information relating to the dictionary data used for detection, the number of detections, and the position and size of the area where the subject (or part) was detected, in association with identification information that uniquely identifies an image signal to be detected.

Since the subject detection unit 130 of the present embodiment performs the subject detection processing by switching between the whole area and local areas in this way, a generation unit 901 generates image data to be subjected to subject detection by the detection unit 902 in order to streamline this processing. The generation unit 901 generates image data to be input to the detection unit 902 from the image signal input to the subject detection unit 130, according to the detection target of the detection unit 902, i.e., dictionary data selected by the dictionary selection unit 904. In other words, the generation unit 901 generates image data for whole area detection when the detection unit 902 performs detection of the whole area, and generates image data for local areas when the detection unit 902 performs detection of local areas.

The detection unit 902 performs subject detection processing based on the dictionary data selected by the dictionary selection unit 904 on the input image data. By the subject detection processing, a detection result indicating the estimation of the area of the image data in which the detection target subject is distributed is output. In one mode, the detection result includes information on the position and size of the area of image data in which the image of the detection target subject appears, and the confidence level of the detection result. In the present embodiment, the detection unit 902 is assumed to be composed of a machine-learned convolutional neural network (CNN). More precisely, the detection unit 902 is configured to have a different CNN mode depending on, for example, information on weights specified in the selected dictionary data, and is configured to be able to detect different types of subjects and subject parts according to the dictionary data.

Accordingly, the dictionary data stored in the dictionary storage unit 905 in the present embodiment is generated by machine learning. That is, each dictionary data is generated by supervised learning in which image data for learning on a detection target subject for the dictionary data is input, and information on the position and size of the area of image data in which the image of the same type of subject (object) appears is used as teacher data (annotation).

The CNN may be, for example, a network in which all of coupling layers and output layers are coupled to a layer structure in which convolution and pooling layers are alternately stacked. In this case, for example, the error back propagation method can be used to train the CNN. The CNN may also be a neo-cognitron CNN, in which a set of feature detection layer (S layer) and feature integration layer (C layer) is defined. In this case, a learning method called “Add-if Silent” can be used to train the CNN.

The dictionary data may be generated, for example, by machine learning in an external device such as a server, and may be obtained by the camera body 120 from this device, or may be generated by machine learning in the camera body 120.

The detection unit 902 may be realized, for example, by a graphics processing unit (GPU) or a circuit specialized for estimation processing by the CNN. In the latter case, for example, a field programmable gate array (FPGA) configured to change the parameters of weights can be used. In addition, the detection unit 902 can use desired learned model other than a learned CNN. The detection unit 902 may be a learned model generated by machine learning such as a support vector machine or decision tree, for example.

Although the present embodiment describes a mode where dictionary data generated by machine learning is used, it is also possible to use this dictionary data in combination with dictionary data generated by a rule base. Here, the dictionary data generated by a rule base is configured by storing an image of a detection target subject or a feature specific to the subject that are determined by the designer, for example. The subject can be detected by comparing the image or feature in the dictionary data with an image or a feature in image data. Rule-based dictionary data is less complicated than the model defined by a learned model and requires less data capacity. Therefore, subject detection using rule-based dictionary data requires less processing time to obtain a detection result and has a smaller processing load, compared to a case where only a learned model is used.

In addition, it is obvious that subject detection by the subject detection unit 130 can employ a desired subject detection method that does not use any learned model.

### Overview of Focus Adjustment

The following will describe an overview of focus adjustment control (control of the position of the focus lens) that the image capturing apparatus 10 of the present embodiment performs to shoot a subject.

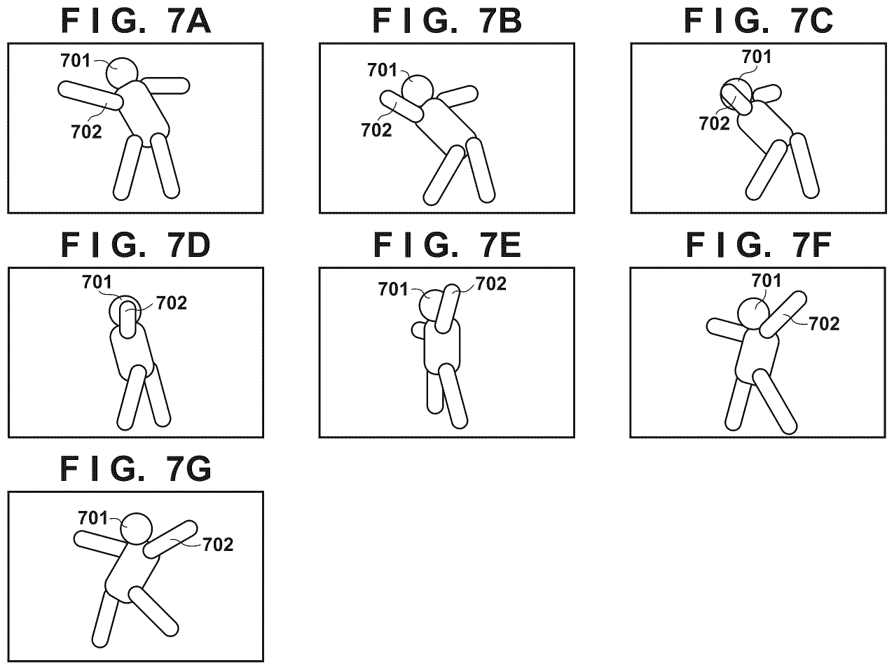

In the image capturing apparatus 10 of the present embodiment, focus adjustment control is performed so that an image is shot with a specific part of a subject in focus. In order to facilitate understanding of the invention, the following description describes a mode in which focus adjustment control is performed so that an image is shot so that, mainly, the face (head) and body of a person who is an athlete in a figure skating competition scene are in focus, as shown in FIGS. 7A to 7G. That is, in the following exemplified mode, the subject detection unit 130 outputs subject detection information that contains information on the positions and sizes of the areas in which the images of the person contained in the captured image signal appear, and the positions and sizes of the areas in which the images of the head and body of the person appear. Also, in the following description, the head and body of a person may be referred to as a “target subject” in the sense that they are the subjects to be brought into focus.

According to the subject detection information output by the subject detection unit 130 and the defocus map output by the phase detection AF unit 129, the defocus amounts in the areas of the head and body of a person can be obtained. On the other hand, when the condition of the athlete changes from moment to moment as explained with reference to FIGS. 7A to 7G, a part of the athlete such as the left arm 702 can enter the area of the head 701, for example. Therefore, even if focus adjustment control is performed based on the defocus amount of this area, there is a possibility that the head 701 may not be in focus.

Accordingly, the image capturing apparatus 10 of the present embodiment is configured to infer the state of the target subject using the inferrer 132 and switch the method for determining the defocus amount to be used as a basis (target) of control in the focus adjustment control, based on the inference result. That is, it is assumed that whether or not the focus adjustment control based on the defocus amount of the areas of the head and body derived from the focus detection signals favorably works depends on the state of the athlete, and the phase detection AF unit 129 performs the control processing differently depending on the state of the athlete inferred by the inferrer 132.

### Functional Configuration of Inferrer 132

Here, a functional configuration of the inferrer 132 of the present embodiment will be described with reference to the block diagram of FIG. 10. As shown in the figure, the inferrer 132 has an inference unit 1002 as a functional configuration for inferring the state of a target subject. The inference unit 1002 will be described as being composed of a machine-learned CNN (inference model), as with the detection unit 902 of the subject detection unit 130. Similar to the detection unit 902, the inference unit 1002 can be, for example, a graphics processing unit (GPU) or a circuit specialized for inference by the CNN. In addition, various other models, such as a vision transformer (ViT), a support vector machine (SVM) combined with a feature extractor, and so on may be used as the inference unit 1002.

In the shown example, the inference unit 1002 repeatedly performs convolution operations in the convolution layer and pooling in the pooling layer, as appropriate, on the input data. The inference unit 1002 then performs a global average pooling process (GAP) to reduce data. Then, the inference unit 1002 inputs the GAP-processed data to a multilayer perceptron (MLP). The inference unit 1002 then performs an optional hidden layer processing and outputs the inference result through the output layer. It is assumed that the weight parameters for each layer are obtained and stored in the storage unit 1004, for example, at the time of factory shipment or firmware update of the camera body 120, and the inference of the inference unit 1002 is performed based on such weight parameters.

The inference unit 1002 of the present embodiment is configured to infer, from the input subject-related data, the range in the depth direction where a target subject is distributed as the state of the target subject. Specifically, the inference unit 1002 infers the range in the depth direction where a target subject captured in a captured image signal exists, using the captured image signal, and the subject detection information, defocus map, and confidence map that correspond to the captured image signal, as inputs. In the present embodiment, the inference unit 1002 infers the range in the depth direction where the target subject exists as the range of defocus amounts corresponding to its nearest and farthest ends thereof. In the following, the range of defocus amounts in which the target subject exists and that is inferred by the inference unit 1002 is referred to as an “inference range. Also, the area of the captured image signal (captured image view angle) in which the image of the target subject is distributed is referred to as a “target area”. Accordingly, the inference unit 1002 derives, as the inference range, the information on the defocus amounts only for the image of the target subject among the images distributed in the target area.

For this purpose, an input unit 1001 generates input data having a plurality of channels in which the captured image signal, and the subject detection information, defocus map, and confidence map that correspond to the captured image signal, which were input to the inferrer 132, are integrated with each other, and inputs the generated input data to the inference unit 1002. At this time, the input unit 1001 can generate the input data, by converting the input data into a subject map in which the pixel value of the target area is set to “1” and the pixel values of other areas are set to “0” based on the information of the areas of the head and body included in the subject detection information.

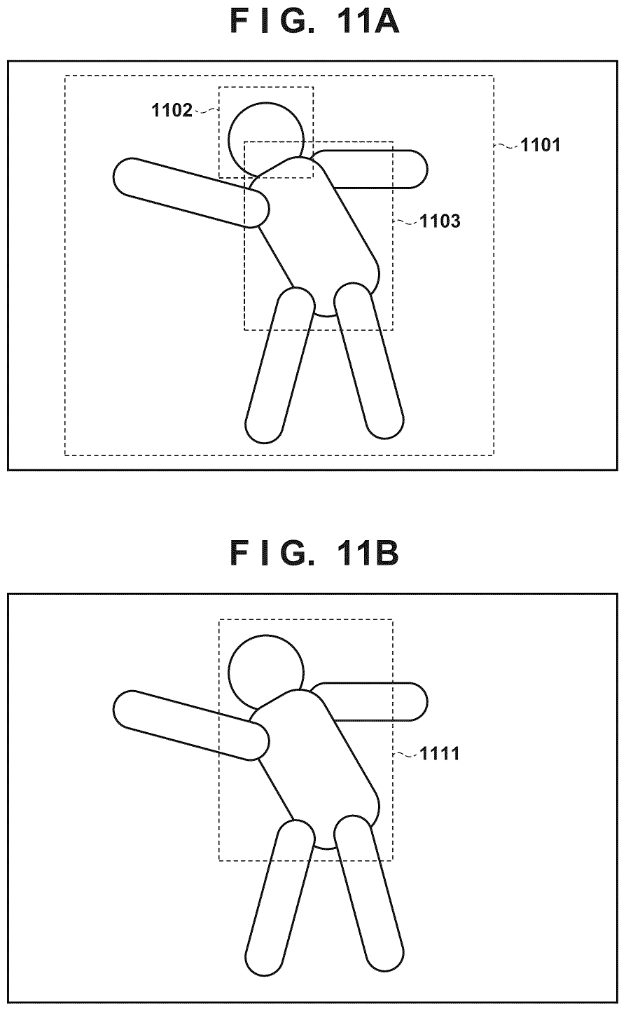

For example, when the subject detection information includes areas as shown in FIG. 11A as the subject detection result, the subject map may have a configuration in which the pixel value of an area 1111 shown in FIG. 11B is set to “1”. The example of FIG. 11A includes an area 1101 in which the whole subject is detected, an area 1102 in which the head of the subject is detected, and an area 1103 in which the body of the subject is detected. In this case, the area 1111 is set to be a rectangular area that encompasses the area 1102 and the area 1103. In the mode of FIG. 11B, the area 1111 is defined so as to circumscribe the area 1102 and the area 1103.

Note that when generating input data, the input unit 1001 may perform up-sampling or down-sampling processing on at least some of the maps (images) in order to make the sizes (resolutions, numbers of pixels) of the maps of the plurality of channels equal to each other.

Once the result of inference by the inference unit 1002 is obtained, the output unit 1003 outputs the inference result to the camera MPU 125 as output data in a predetermined format. In the present embodiment, it is assumed that the output data includes information on the range of defocus amounts for the target area. It is assumed that the output unit 1003 associates the output data with meta-information such as identification information of the captured image signal of the input data used for inference, and outputs the resultant.

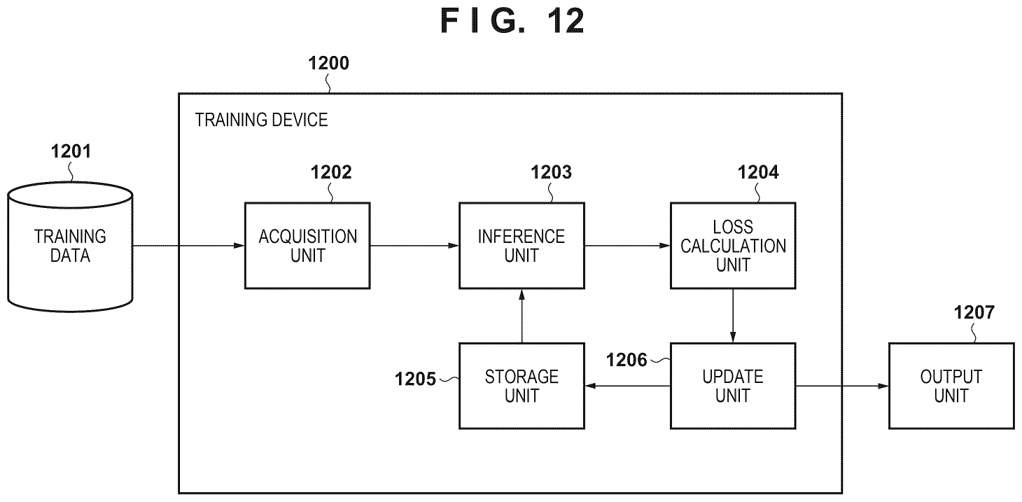

The inference unit 1002 that infers the range of defocus amounts for a target subject can be generated, for example, by a training device 1200 as shown in FIG. 12. The training device 1200 may be an external device (such as PC or server) different from the image capturing apparatus 10, or may be included in the image capturing apparatus 10.

For an image to be learned (training image), the training device 1200 is configured to machine-learn the range in the depth direction of the training image where the head and body of a subject are actually distributed. Accordingly, an acquisition unit 1202 of the training device 1200 acquires, as training data 1201, correct answer information indicating the range of defocus amounts of the target area in the training image. In addition, the training data 1201 includes the training image, and the defocus map, confidence map, and subject detection information that correspond to the training image.

The correct answer information is determined, for example, based on the distribution of defocus amounts of the pixels that remain after excluding the pixels of the focus detection area that includes obstructions in background and foreground and parts of a subject other than the head and body, from the defocus map corresponding to the training image. That is, the minimum and maximum values of the defocus amounts of the remaining pixels respectively indicate the defocus amounts corresponding to the farthest and nearest ends of the distribution of the head and body of the subject in the depth direction. Such excluded pixels may be selected during training, for example, by a person visually checking the training image.

The inference unit 1203 is composed of the CNN, as with the inference unit 1002 of the inferrer 132. The inference unit 1203 is configured so that the weight parameters of a network used in machine learning can be changed. In the mode shown in FIG. 12, the weight parameters are stored in the storage unit 1205, and the inference unit 1203 reads out the weight parameters to perform inference during training. Based on the weight parameters, the inference unit 1203 infers the range of defocus amounts in the target area from the training image, defocus map, confidence map, and subject detection information of the training data 1201.

A loss calculation unit 1204 derives the difference between the inference result of the inference unit 1203 and the correct answer information of the training data 1201, as a loss. An update unit 1206 updates the weight parameters in the storage unit 1205 so that the loss derived by the loss calculation unit 1204 becomes smaller. The updated weight parameters are used for next training by the inference unit 1203. By repeating such learning for multiple types of training images, the inference unit 1203 reduces the loss and serves as a machine learning model capable of accurately inferring the range of defocus amounts of a target area of a training image. It is sufficient that the weight parameters updated by the update unit 1206 are output when, for example, the conditions for learning convergence are met, and are supplied to the camera body 120 or the like so as to be stored in the storage unit 1004. That is, as a result of the weight parameters updated through such machine learning being stored in the storage unit 1004, the inference unit 1002 is also able to derive highly accurate inference results for input data.

### Method for Determining Target Defocus Amount

The control processing of focus adjustment that is performed by the image capturing apparatus 10 moves the focus lens 104 so that the defocus amount of the image of a target subject is 0. That is, in the control processing performed by the focus adjustment unit 133, the defocus amount of the image of the target subject in an obtained captured image signal is determined as the target for focus adjustment, and the focus adjustment is performed so that the defocus amount is 0. In more detail, the focus adjustment unit 133 determines the target defocus amount based on the distribution of defocus amounts included in the target area of the defocus map.

On the other hand, as described above, depending on the condition of a person (subject), the target area may include objects other than the target subject (such as other parts of the person or obstructions in the foreground). Therefore, the focus adjustment unit 133 first performs processing for extracting defocus amounts included in the inference range from the defocus amounts included in the target area.

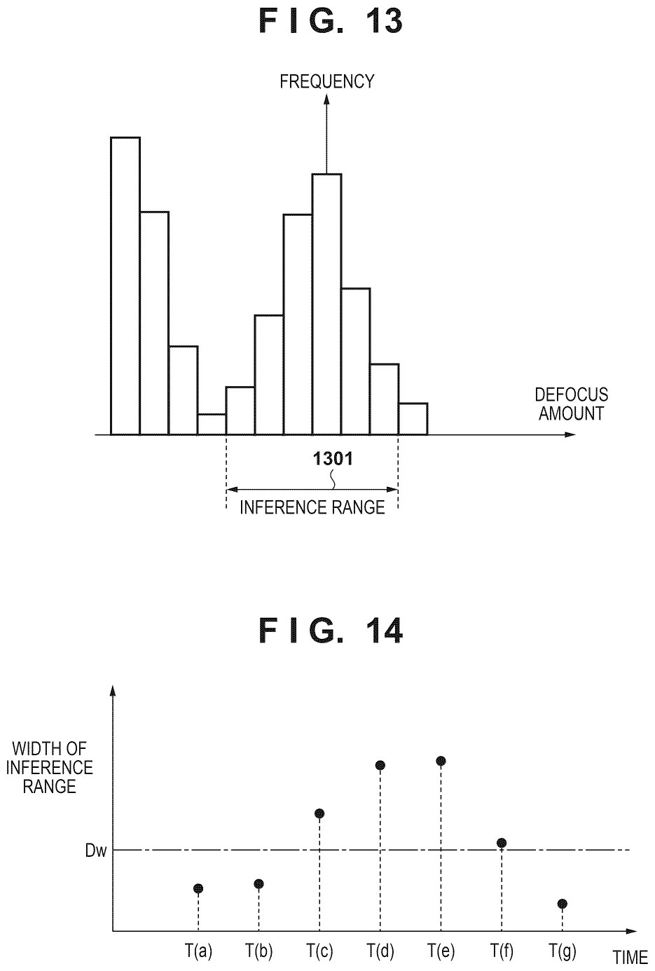

For example, when the frequency distribution of the defocus amounts in the target area is as shown in FIG. 13, the focus adjustment unit 133 extracts the defocus amounts included in an inference range 1301 from among the distribution. In the frequency distribution shown in FIG. 13, the horizontal axis indicates the defocus amount, and the larger the defocus amount is, the closer to the object (closer to the image capturing apparatus 10) it is.

Through the extraction, the defocus amount to be referred to in determining the target defocus amount can be limited to the inference range that was inferred by the inference unit 1002 as being a range in which the target subject is distributed. In other words, among the defocus amounts distributed in the target area of the defocus map, defocus amounts derived from objects other than the target subject and erroneous defocus amounts caused by the presence of such objects can be excluded by the extraction.

The focus adjustment unit 133 then determines the target defocus amount based on the defocus amounts extracted in this way (hereinafter referred to as the extracted defocus amounts). At this time, the focus adjustment unit 133 switches the method of determining the target defocus amount according to the width of the inference range (the width of the value range of the defocus amounts). Since the width of the inference range indicates the extent to which the target subject exists while extending in the depth direction, the position to which the focus lens should be moved for shooting changes according to that extent.

Here, if the width of the inference range is less than a threshold value (narrow), the target subject can be regarded as existing without extending in the depth direction, so the focus adjustment unit 133 determines the value corresponding to the nearest end of the extracted defocus amounts as the target defocus amount. That is, if the width of the inference range is less than the threshold value, it can be expected that shooting is possible in a state where the target subject is suitably in focus from the nearest end to the farthest end of the target subject, by performing focus adjustment control using the defocus amount corresponding to the nearest end as the target defocus amount.

In contrast, if the width of the inference range is not less than the threshold value (exceeds or is equal to the threshold value), it is meant that the target subject exists while extending in the depth direction. In such a situation, if focus adjustment control is performed using the defocus amount corresponding to the nearest end as the target defocus amount as in the case where the width of the inference range is less than the threshold value, the portion of the target subject that is far away from the image capturing apparatus 10 may not be included in the depth of field. In the situation where the athlete spins as shown in FIGS. 7A to 7G, an abrupt change in the position of the target subject occurs between time T(a) and time T(g) as shown in FIG. 14, and the range of the target subject in the depth direction varies. Here, the alphabets in parentheses attached to time T respectively correspond to the captured image signals in FIGS. 7A to 7G. That is, for example, time T(c) corresponds to the timing of acquiring the captured image signal in FIG. 7C, and time T(f) corresponds to the timing of acquiring the captured image signal in FIG. 7F. The example of FIG. 14 shows that the width of the inference range exceeds a threshold value Dw during the period from time T(c) to T(f). Therefore, if the defocus amount corresponding to the nearest end is set to the target defocus amount in a situation where such variations occur, the focus lens may move frequently, making it difficult to reach a state where the target subject is in focus, and it may be impossible to start shooting. Therefore, if the width of the inference range is not less than the threshold value, the focus adjustment unit 133 determines the average of the extracted defocus amounts as the target defocus amount. That is, if the width of the inference range exceeds the threshold value, it can be expected that variations in the in-focus state is reduced and the target subject is stably kept in focus, by performing focus adjustment using the average of the extracted defocus amounts as the target defocus amount.

Note that since image capture by the image capturing apparatus 10 is performed intermittently, it is assumed that subject detection and focus detection are performed each time image capture is performed, and the focus adjustment unit 133 acquires the inference range and performs focus adjustment control based on the captured image signal, and the subject detection information and focus detection results that correspond to the captured image signal. Alternatively, these processes need not be performed on all of image capture performed by the image capturing apparatus 10, that is, on all of the image signals acquired as live view images, but may be performed only on the image signals acquired at predetermined intervals, among them. In addition, the focus adjustment control of the focus adjustment unit 133 involving the inference by the inferrer 132 may be performed only when an operation input is made in response to an instruction to shoot an image for recording.

### Shooting Processing

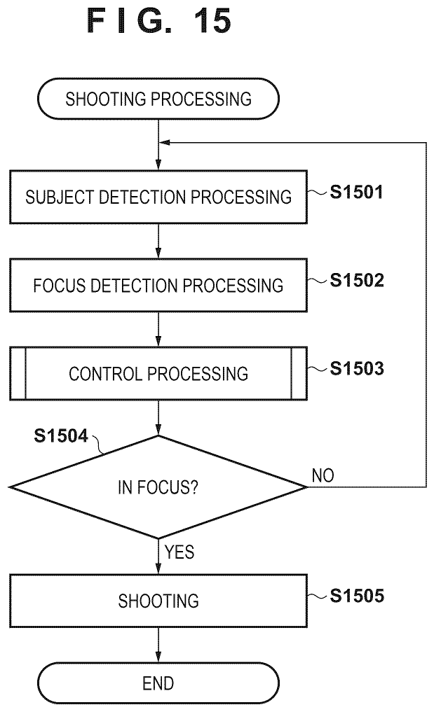

The following will describe specific shooting processing performed by the camera body 120 of the present embodiment having the above-described configuration with reference to the flowchart of FIG. 15. The processing corresponding to the flowchart can be realized by the camera MPU 125 reading a corresponding processing program stored in, e.g., a ROM, expanding it into a RAM, and executing it. This shooting processing is described, for example, as being started when an operation input in accordance with a shooting instruction is detected. Note that, in the present embodiment, description will be given on the assumption that a still image for recording is shot and recorded in accordance with a shooting instruction. However, the implementation of the present invention is not limited to this, and shooting of a moving image for recording may be started in response to such an instruction.

In step S1501, the subject detection unit 130 executes subject detection processing based on a signal for subject detection under the control of the camera MPU 125. Since the head and body of the person (athlete), who is a subject, are the target subjects in the present embodiment, the subject detection unit 130 detects at least the entire area, the head area, and the body area of the subject by causing the detection unit 902 to use different dictionary data, for example. When the subject detection processing is complete, the subject detection unit 130 configures and outputs subject detection information.

In the present embodiment, for ease of understanding the invention, description is given on the assumption that one subject (person) is captured within the captured image view angle as shown in FIGS. 7A to 7G, and the focus adjustment control is performed so that the head and body of the subject is brought into focus, but the implementation of the present invention is not limited to this. For example, if multiple subjects are captured within the captured image view angle, it is sufficient that one of the multiple subjects is selected as the main subject, and the head and body of the main subject serving as target subjects to be brought into focus are subjected to focus adjustment processing. The main subject may be determined based on the order of priority from the closest position to the center of the captured image view angle (lowest image height) within the area in which the subjects were detected.

In step S1502, the phase detection AF unit 129 executes focus detection processing under the control of the camera MPU 125. When the focus detection processing is complete, the phase detection AF unit 129 generates and outputs a defocus map and a confidence map.

In step S1503, the focus adjustment unit 133 performs control processing to control focus adjustment under the control of the camera MPU 125.

### Control Processing

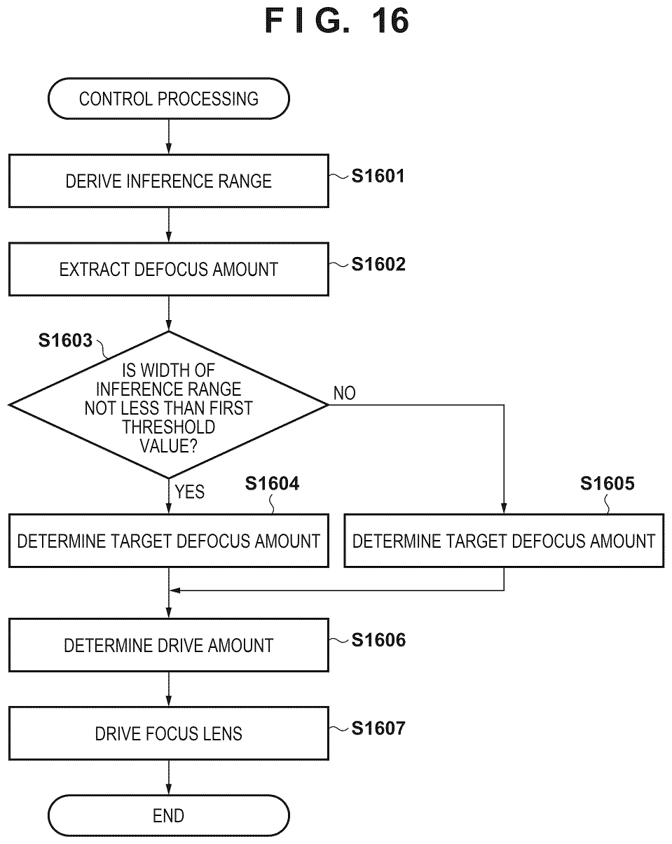

The control processing that is executed in this step is described in detail with reference to the flowchart of FIG. 16.

In step S1601, the inferrer 132 derives the inference range for the target subject based on the captured image signal, and the subject detection information, defocus map, and confidence map that correspond to the captured image signal, under the control of the camera MPU 125. As described above, in this step, the input unit 1001 of the inferrer 132 generates input data containing a subject map of the target subject based on these types of data, and inputs the generated input data to the inference unit 1002. The inference unit 1002 infers the range of defocus amounts (inference range) of the target subject from the input data based on the weight parameter information stored in the storage unit 1004. The output unit 1003 outputs information on the inference range derived by the inference unit 1002.

In step S1602, the focus adjustment unit 133 extracts the defocus amounts included in the target area of the defocus map that corresponds to the captured image signal based on the inference range derived in step S1601. As described above, with the processing in this step, the extracted defocus amounts are specified from among the defocus amounts included in the target area of the defocus map.

In step S1603, the focus adjustment unit 133 determines whether or not the width of the inference range derived in step S1601 is not less than a first threshold value (Dw). If it is determined that the width of the inference range is not less than the first threshold value, the focus adjustment unit 133 moves the process to step S1604, and if it is determined that the width is less than the first threshold value, the focus adjustment unit 133 moves the process to step S1605.

In step S1604, the focus adjustment unit 133 determines the average of the extracted defocus amounts as the target defocus amount.

On the other hand, if it is determined in step S1603 that the width of the inference range is less than the first threshold value, the focus adjustment unit 133 determines, in step S1605, the maximum value of the extracted defocus amounts as the target defocus amount. In other words, the focus adjustment unit 133 determines the defocus amount corresponding to the nearest end among the extracted defocus amounts as the target defocus amount.

In step S1606, the focus adjustment unit 133 determines the drive amount of the focus lens 104 to be moved in focus adjustment based on the determined target defocus amount.

In step S1607, the focus adjustment unit 133 transmits the information regarding the drive amount of the focus lens 104 together with a drive request to the lens unit 100, and causes the lens MPU 117 to drive the focus lens 104. In response to the drive request, the lens MPU 117 controls the focus drive circuit 116 to move the focus lens 104 by the specified drive amount.

After the control processing is complete, the shooting processing moves to step S1504.

In step S1504, the camera MPU 125 judges whether or not the target subject is in focus based on the defocus map generated by the phase detection AF unit 129 with respect to a captured image signal obtained after the movement of the focus lens 104. If it is determined that the target subject is in focus, the camera MPU 125 moves the process to step S1505, and if it is determined that the subject is not in focus, the camera MPU 125 returns the process to step S1501.

In step S1505, the camera MPU 125 executes control for shooting a still image for recording. With this control, a still image for recording is generated and stored in memory 128.

As described above, the information processing device of the present embodiment can perform stable focus adjustment regardless of a change in the state of a subject. That is, the information processing apparatus infers the range in the depth direction where the subject exists based on a captured image signal, and the subject map, defocus map, and confidence map that correspond to the captured image signal, and switches the method of determining the target defocus amount for use in focus adjustment according to the inference result. With this configuration, the target defocus amount can be determined by excluding defocus amounts affected by obstructions or the like. For example, even in a scene where an arm extends in front of the face of a person, a range of defocus amounts excluding the arm area can be extracted from the defocus amounts based on the focus detection area corresponding to the face. Even if the inference range is widened due to an abrupt state change in the subject, it is possible to avoid such a situation where the in-focus state of the subject is not stable due to the abrupt change.

Note that although the present embodiment has described a mode where the detection unit 902 detects a subject that is a person and the inferrer 132 infers the range of defocus amounts corresponding to the head and body of the person, the implementation of the invention is not limited to this. That is, the types of subjects to be subjected to detection and inference are not limited to persons, but can include, for example, vehicles and animals. In such a case, the processing used for detection and inference can be different from the case where the subject type is person. Therefore, for example, the weight parameters used by the detection unit 902 and the inference unit 1002 may be provided for each type of subject and may be configured to be changeable.

Also, the present embodiment has described a mode where the head and body of a person are target subjects, but it is obvious that the implementation of the invention is not limited to this. For example, the part of the subject to serve as the target subject may be configured to be settable by the photographer.

Although, in the present embodiment, the first threshold value has been described as being predetermined, the implementation of the invention is not limited to this. The first threshold value may be adaptively changeable according to the subject distance, the aperture value of the lens, or the subject type, for example.

Although the present embodiment has been described so that the drive amount of the focus lens 104 is determined based on the target defocus amount, the implementation of the present invention is not limited to this. The focus adjustment unit 133 may determine the drive amount for the focus position derived based on the focus position predicted from the history of the focus position of the focus lens 104 up to the last focus position and the focus position of the target defocus amount, for example.

### Embodiment 2

The above-described embodiment has described a mode in which the method for determining the target defocus amount from among extracted defocus amounts is switched based on whether or not an inference range obtained for each captured image signal exceeds the first threshold value, but the implementation of the present invention is not limited to this. For example, in a situation where the width of the inference range is stable for a predetermined period of time even if the inference range exceeds the first threshold value, if the average of the extracted defocus amounts is used as the target defocus amount, this may give the photographer the impression that the target subject is still not properly in focus. For this reason, the present embodiment will describe a mode in which the target defocus amount is determined based on a plurality of defocus amounts included in the extracted defocus amounts when the in-focus state is not stable due to an abrupt state change in the target subject. In more detail, the focus adjustment unit 133 of the present embodiment determines whether or not an abrupt state change has occurred in the target subject based on whether or not the amount of temporal variation in the width of the inference range is not less than a predetermined threshold value, and switches the method of determining the target defocus amount.

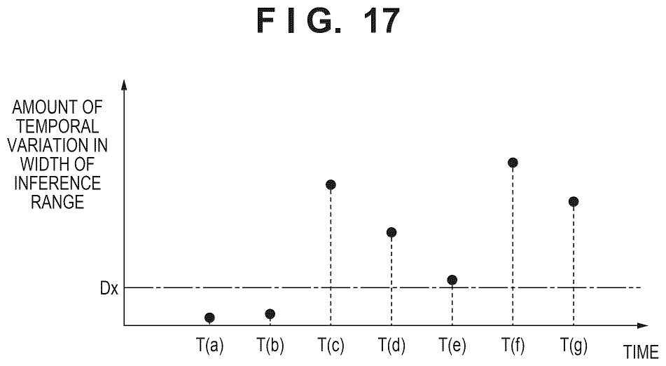

The amount of temporal variation in the width of the inference range can be derived, for example, with respect to each of captured image signals that are sequentially acquired for subject detection, focus detection, and inference, as the difference between the width of the inference range of the captured image signal and the width of the inference range for the captured image signal acquired at the last acquisition timing. In the mode in which the state of the athlete changes continuously as shown in FIGS. 7A to 7G, the difference in the width of the inference range obtained by the inferrer 132 is as shown in FIG. 17, for example. The example in FIG. 17 shows that the amount of temporal variation in the width of the inference range (difference from the width of the last inference range) exceeds a threshold value Dx during the period from time T(c) to T(g). In other words, it is assumed that the distribution of the target subject in the depth direction abruptly varies during this period. Therefore, if the defocus amount corresponding to the nearest end is set to the target defocus amount in a situation where such variations in the amount of temporal variation occur, the focus lens may move frequently, making it difficult to reach a state where the target subject is in focus, and it may be impossible to start shooting. Therefore, if the amount of temporal variation in the width of the inference range is not less than the threshold value, the focus adjustment unit 133 determines the average of the extracted defocus amounts as the target defocus amount. That is, if the amount of temporal variation in the width of the inference range exceeds the threshold value, it can be expected that variations in the in-focus state is reduced without forcing the focus lens 104 to follow the abrupt state change, by performing focus adjustment using the average of the extracted defocus amounts as the target defocus amount.

### Control Processing

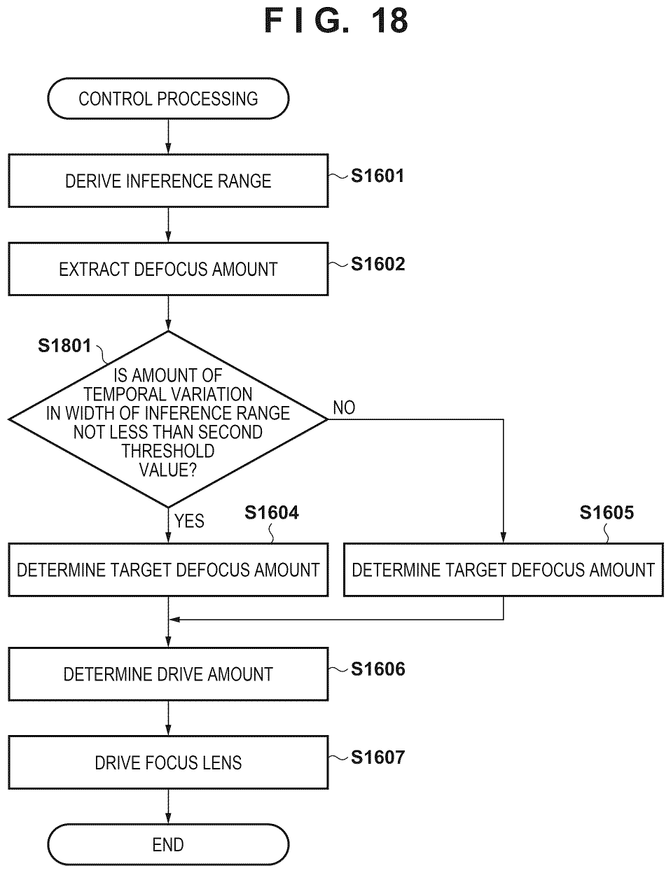

The following will describe the control processing that is executed in step S1503 of the shooting processing of the present embodiment in detail with reference to the flowchart of FIG. 18. Note that in the control processing of the present embodiment, steps that perform the same processing as the control processing in Embodiment 1 are added with the same reference numbers, and descriptions thereof are omitted. The following description is limited to the steps that perform processing characteristic to the present embodiment.

Once, in step S1602, the extracted defocus amounts for the captured image signal acquired at the current acquisition timing are specified, the focus adjustment unit 133 determines, in step S1801, whether or not the amount of temporal variation in the width of the inference range is not less than the second threshold value (Dx). First, the focus adjustment unit 133 derives the difference between the width of the inference range of the target subject obtained for the captured image signal acquired at the current acquisition timing and the width of the inference range of the target subject obtained for the captured image signal acquired at the last acquisition timing, as the amount of temporal variation. The focus adjustment unit 133 then compares the derived amount of temporal variation and the second threshold value to make the determination in this step. If it is determined that the amount of temporal variation in the width of the inference range is not less than the second threshold, the focus adjustment unit 133 moves the process to step S1604, and if it is determined that the amount of temporal variation is less than the second threshold, the focus adjustment unit 133 moves the process to S1605.

With this, according to the control processing of the present embodiment, stable focus adjustment can be realized when it is inferred that an abrupt change occurs in the range in the depth direction where the target subject exists.

Note that although the present embodiment has described a mode in which the amount of temporal variation in the width of the inference range is derived as the difference from the width of the last obtained inference range, the implementation of the present invention is not limited to this. The amount of temporal variation in the width of the inference range may be derived based on information on the inference range for the last predetermined period.

Although, in the present embodiment, the second threshold value has been described as being predetermined, the implementation of the invention is not limited to this. Similar to the first threshold, the second threshold value may be adaptively changeable according to the subject distance, the aperture value of the lens, or the subject type, for example.

### Modification 1

The above-described embodiment has described a mode in which the average of extracted defocus amounts is determined as the target defocus amount when the target subject is in a state of extending in the depth direction, but the implementation of the present invention is not limited to this. The target defocus amount determined in this state may be the median in the distribution of the extracted defocus amounts.

### Modification 2

The above-described Embodiment 1 has described a mode in which the average of extracted defocus amounts is determined as the target defocus amount if the width of the inference range exceed the first threshold value, but the implementation of the present invention is not limited to this. The focus adjustment unit 133 may determine the defocus amount corresponding to the nearest end among the extracted defocus amounts as the target defocus amount if, for example, the width of the inference range is less than the first threshold value, and may not determine a new target defocus amount if the width of the inference range exceeds the first threshold value. In this case, the focus adjustment unit 133 can determine the target defocus amount as if the target defocus amount determined for the captured image signal that was last acquired for inference is directly used. In other words, if the width of the inference range exceeds the first threshold value, the focus adjustment unit 133 does not determine a new target defocus amount based on the extracted defocus amounts, but re-determines the last-determined defocus amount as the target defocus amount.

In this way, stable focus adjustment can be realized because the target defocus amount is not changed depending on the defocus amount included in the extracted defocus amounts when it is inferred that a state change that affects the distribution of the target subject existing in the depth direction is occurring in the target subject. In other words, if the width of the inference range exceeds the first threshold value, the focus lens 104 is controlled so as not to be driven temporarily, thus stabilizing the focus adjustment regardless of the position change of the target subject.

Such control for determining the target defocus amount is also applicable to Embodiment 2. That is, the above-described Embodiment 2 has described a mode in which the average of extracted defocus amounts is determined as the target defocus amount if the amount of temporal variation in the inference range exceeds the second threshold value, but the implementation of the present invention is not limited to this. The focus adjustment unit 133 may determine the defocus amount corresponding to the nearest end among the extracted defocus amounts as the target defocus amount if, for example, the amount of temporal variation of the inference range is less than the second threshold value, and may not determine a new target defocus amount if the amount of temporal variation of the inference range exceeds the second threshold value. In this case, the focus adjustment unit 133 can determine the target defocus amount as if the target defocus amount determined for the captured image signal that was last acquired for inference is directly used.

### Embodiment 3

The above-described embodiment has described a mode in which, in a situation where an abrupt state change is assumed to occur in the target subject, the average of the defocus amounts in the target area extracted in the inference range is determined as the target defocus amount irrespective of the value range of the inference range. On the other hand, state changes in the target subject do not occur uniformly in the depth direction. That is, state changes of the target subject do not necessarily occur uniformly on both the side closer to and farther away from the image capturing apparatus 10 with reference to the subject distance at which the subject is currently in focus. Therefore, if a state changes in such a way that the range in the depth direction where the target subject exists temporarily extends to either side, the in-focus state of the target subject may not be stable when a defocus amount such as an average is used as the target defocus amount. The present embodiment describes a mode in which the bias of the state change of a target subject is inferred based on the inference range, and a different method of determining the target defocus amount is used according to the result of the inference.

The bias of the state change can be determined, for example, based on the position (focus positions) of the focus lens 104 that corresponds to each of the nearest and farthest ends of the inference range. The focus position of the focus lens 104 can be derived by converting the defocus amount (maximum or minimum value of the inference range) at the corresponding end into the drive amount of the focus lens 104 and then adding the drive amount to the current focus position of the focus lens 104. Hereinafter, the focus position corresponding to the nearest end of the inference range is described as a first focus position and the focus position corresponding to the farthest end is described as a second focus position.

When determining the target defocus amount, the focus adjustment unit 133 switches the determination method based on the temporal variation in the first and second focus positions (i.e., the temporal variation in the position of the focus lens 104) instead of the width of the inference range. In the present embodiment, the focus adjustment unit 133 determines that an abrupt state change has occurred in the target subject, for example, when the sum of absolute values of the differences between the average focus position in the last predetermined period and the focus position at each time during this period exceeds a predetermined threshold value. This state shows a so-called “pulsation” mode in which the focus position instantaneously increases/decreases and returns in the time direction. In other words, the focus adjustment unit 133 can determine that an abrupt change in the state of the subject has occurred in the corresponding optical axis direction, if the width of the variation of the focus position corresponding to either end in a predetermined period exceeds the predetermined width.

For example, if a variation that exceeds a predetermined width is not occurring in either of the first and second focus positions, it can be determined that the state of the subject is stable. In this case, the focus adjustment unit 133 can determine the defocus amount corresponding to the nearest end among the extracted defocus amounts as the target defocus amount. Also, for example, if a variation that exceeds a predetermined width is occurring in at least one of the first focus position and the second focus position, it can be determined that an abrupt change in the state of the subject has occurred. Here, if there is a difference in variation at each of the focus positions, the spread in the depth direction due to the state change of the target subject is biased towards the side that is closer to the image capturing apparatus 10 from the distance of the subject in focus and towards the side that is farther away therefrom.

If there is a bias in the depth direction in the state change of the target subject, the focus adjustment unit 133 determines the target defocus amount in accordance with the side (the near side/far side) where the state is considered to be stable. In the present embodiment, when an abrupt state change of the target subject is occurring on the near side, the focus adjustment unit 133 determines a value offset by a predetermined amount from the defocus amount corresponding to the farthest end among the extracted defocus amounts to the near side, as the target defocus amount. Also, when an abrupt state change of the target subject is occurring on the far side, the focus adjustment unit 133 determines a value offset by a predetermined amount from the defocus amount corresponding to the farthest end among the extracted defocus amounts to the far side, as the target defocus amount. In this way, focus adjustment control is performed in a manner such that the effect of biased and abrupt state changes is reduced, thus ensuring stable focus tracking.

Note that if abrupt state changes occurring in the target subject on the near side and the far side are in the same range (the difference in variation width between the first and second focus positions is less than a predetermined threshold value), the focus adjustment unit 133 may determine the average as the target defocus amount, as in Embodiments 1 and 2.

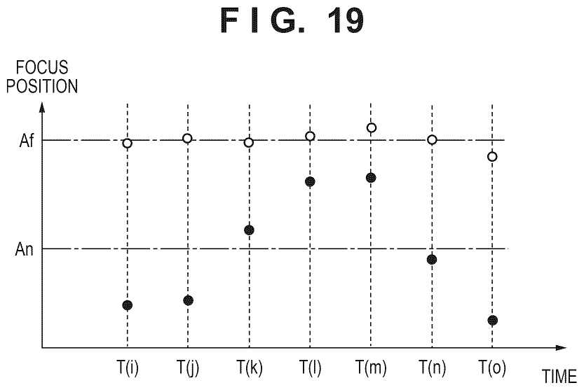

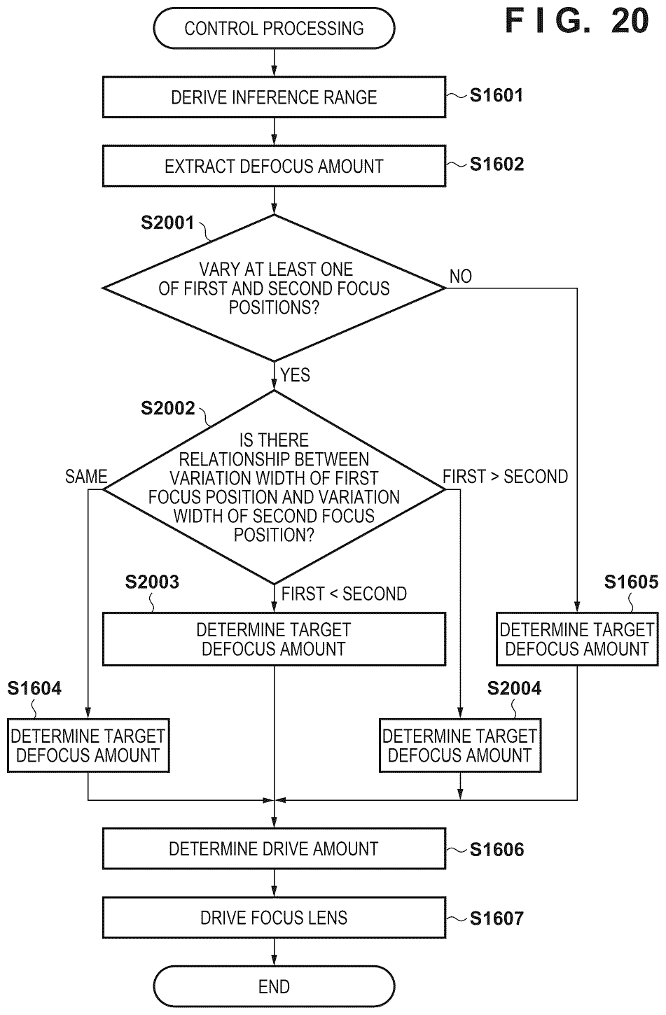

FIG. 19 shows examples of temporal variations in the first focus position and temporal variations in the second focus position based on the inference range. In the figure, the black circle at each time shows the focus position corresponding to the nearest end of the inference range at that time (first focus position) and the white circle at each time shows the focus position corresponding to the farthest end of the inference range at that time (second focus position). Also, the value An represents the average of the first focus positions at times T(i) to T(o) and the value Af represents the average of the second focus positions during the same period. In the shown example, abrupt variations appear only on the side of the first focus position corresponding to the nearest end, so the defocus amount offset by a predetermined amount from the defocus amount corresponding to the farthest end among the extracted defocus amounts to the near side is determined as the target defocus amount.

### Control Processing

The following will describe the control processing that is executed in step S1503 of the shooting processing of the present embodiment in detail with reference to the flowchart of FIG. 20. Note that in the control processing of the present embodiment, steps that perform the same processing as the control processing in Embodiment 1 are added with the same reference numbers, and descriptions thereof are omitted. The following description is limited to the steps that perform processing characteristic to the present embodiment.

Once, in step S1602, the extracted defocus amounts are specified, the focus adjustment unit 133 determines, in step S2001, whether or not a variation exceeding a predetermined width occurs in at least one of the focus positions that correspond to the nearest and farthest ends of the inference range of the last predetermined period. If it is determined that a variation exceeding the predetermined width occurs in at least one of the first and second focus positions of the inference range, the focus adjustment unit 133 moves the process to step S2002. If it is determined that a variation exceeding the predetermined width does not occur in either of the first and second focus positions of the inference range, the focus adjustment unit 133 moves the process to step S1605.

In step S2002, the focus adjustment unit 133 determines which of the variation width of the first focus position or the variation width of the second focus position is greater. If it is determined that the variation width of the first focus position is greater than the variation width of the second focus position, the focus adjustment unit 133 moves the process to step S2003, and if the variation width of the second focus position is greater than the variation width of the first focus position, the focus adjustment unit 133 moves the process to step S2004. If it is determined that the variation width of the first focus position and the variation width of the second focus position are in the same range, the focus adjustment unit 133 moves the process to step S1604. Here, it is assumed that the variation width of the first focus position and the variation width of the second focus position are considered to be in the same range when the difference between them is less than a predetermined value. Therefore, the state where one of the focus positions has a larger variation width may require that the difference in the variation range is not less than the predetermined value.

In step S2003, the focus adjustment unit 133 determines the value that is reduced (offset) by a predetermined amount from the maximum value among the extracted defocus amounts as the target defocus amount. That is, the focus adjustment unit 133 determines the value that is offset by a predetermined amount from the defocus amount corresponding to the farthest end among the extracted defocus amounts to the near side, as the target defocus amount.

On the other hand, if it is determined in step S2002 that the variation width of the second focus position is greater, the focus adjustment unit 133 determines, in step S2004, the value that is increased (offset) by a predetermined amount from the minimum value among the extracted defocus amounts as the target defocus amount. In other words, the focus adjustment unit 133 determines the value offset by a predetermined amount from the defocus amount corresponding to the nearest end among the extracted defocus amounts, as the target defocus amount.

With this, according to the control processing of the present embodiment, when it is inferred that an abrupt change occurs in the range in the depth direction where the target subject exists, stable focus adjustment can be realized according to the state change.

Note that the description of the present embodiment has been given on the assumption that the sum of the absolute values of the differences between the average focus position in the last predetermined period and the focus position at each time during that period is used to determine whether or not an abrupt state change has occurred in the target subject. However, the implementation of the present invention is not limited to this, and the determination may be made based on the sum of the absolute values of the differences between a statistically derived regression curve based on the focus position at each time during a predetermined period, and the focus positions at each time, for example.

### Modification 3

The above-described embodiments and modifications have described a mode in which the inferrer 132 infers the range of defocus amounts as information indicating the range in the depth direction where a target subject exists, but the implementation of the present invention is not limited to this. The range of defocus amounts is one mode of defining the range in the depth direction, and it is obvious that other parameters can be used to specify the range in the depth direction of the target subject. Such parameters can include, for example, other parameters from which the range in the depth direction can be derived, such as focus positions, subject distances, or image shift amounts in signals for focus detection.

### Modification 4

The above-described embodiments have described a mode in which a defocus map is generated based on the focus detection results of the plurality of focus detection areas set for the entire captured image view angle, and subject detection information for a specific subject (person) captured in the captured image view angle is generated. However, the implementation of the present invention is not limited to this, and subject detection may be performed only in, for example, predetermined some areas of the captured image view angle, such as the center thereof. The generation of the defocus map may also be performed based only on the focus detection results of the focus detection areas corresponding to the areas in which the subject was detected. In such a mode, by resizing the focus detection areas to increase density and place the resized focus detection areas in the areas where the subject was detected, it is possible to obtain a much highly detailed defocus map.

In order to reduce the computational load in the inferrer 132, the information input to the inferrer 132 and the input data generated by the input unit 1001 of the inferrer 132 may contain, for example, information with the areas where the target subject is distributed cut out.

### Modification 5

The above-described embodiments and modifications have described a mode in which the image signal, and the subject detection information, defocus map, and confidence map that correspond to this image signal are trained by the training device 1200, in order to establish an inference model to be used in the inferrer 132. Also, in this mode, the inference by the inferrer 132 has been described as requiring the target captured image signal, and the subject map, defocus map, and confidence map that correspond to this captured image signal for inputs. However, the implementation of the present invention is not limited to this, and an inference model capable of inferring the range in the depth direction where the target subject exists without inputting all of these can be employed as the inferrer 132. For example, in a mode where the defocus map is learned in advance in a limited manner for information having a predetermined confidence level, or in a mode where the scene to be shot, the subject type, and the image capture settings are limited, the captured image signals and the confidence map can be omitted during machine learning and inference. That is, the inferrer 132 may employ an inference model configured to be able to infer the range in the depth direction where the subject exists, based on information on the distribution of the subject areas in the captured image view angle and the focus detection results of the plurality of focus detection areas in this captured image view angle.

Similarly, the above-described embodiments and modifications have described a method of determining the target defocus amount from extracted defocus amounts based on information on an inference range as the target parameter for focus adjustment, but the implementation of the present invention is not limited to this. It is obvious that the target parameter used for focus adjustment may be any other parameter that can be converted into a defocus amount, such a focus position or a subject distance.

### Modification 6

The above-described embodiments and modifications have described a mode in which defocus amounts included in the inference range are extracted from the defocus amounts included in the target area, and the target defocus amount is determined based on the extracted defocus amounts. However, the implementation of the present invention is not limited to this. The present invention may, for example, determine the target parameter such as the target defocus amount based on the inference range inferred using information on the distribution of the subject areas within the captured image view angle and the focus detection results as inputs.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-075409, filed May 7, 2024, which is hereby incorporated by reference herein in its entirety.

What is claimed is:

1. An information processing apparatus that determines a target parameter for use in focus adjustment when shooting a subject, comprising:
at least one processor and/or circuit; and
at least one memory storing a computer program, which causes the at least one processor and/or circuit to function as following units:
a first acquisition unit configured to acquire information relating to a distribution of subject areas in a captured image view angle;
a second acquisition unit configured to acquire focus detection results of a plurality of focus detection areas provided for the captured image view angle;
an inference unit configured to infer a range in a depth direction in which the subject exists, based on the information relating to the distribution of the subject areas and the focus detection results of the plurality of focus detection areas; and
a determination unit configured to determine the target parameter based on the inference range in the depth direction,
wherein the determination unit switches a method of determining the target parameter according to the range in the depth direction.

2. The information processing device according to claim 1,
wherein the determination unit extracts focus detection results included in the inference range in the depth direction from the focus detection results of the plurality of focus detection areas, and determines the target parameter based on the extracted focus detection results.

3. The information processing device according to claim 2,
wherein the method of determining the target parameter includes a first determination method of determining a value corresponding to a nearest end among the extracted focus detection results as the target parameter, and a second determination method of determining a value not corresponding to the nearest end among the extracted focus detection results as the target parameter.

4. The information processing device according to claim 3,
wherein the determination unit determines the target parameter using the second determination method if a width of the range in the depth direction is greater than a first threshold value, and determines the target parameter using the first determination method if the width of the range in the depth direction is less than the first threshold value.

5. The information processing device according to claim 3,
wherein the acquisition of the information relating to the distribution of the subject areas by the first acquisition unit and the acquisition of the focus detection results of the plurality of focus detection areas by the second acquisition unit are performed intermittently,
the inference unit infers the range in the depth direction for each acquisition timing based on the intermittently acquired information relating to the distribution of the subject areas and the intermittently acquired focus detection results of the plurality of focus detection areas, and
the determination unit determines the target parameter using the second determination method if the amount of temporal variation in the width of the range in the depth direction is greater than a second threshold value, and
determines the target parameter using the first determination method if the amount of temporal variation in the width of the range in the depth direction is less than the second threshold value.

6. The information processing device according to claim 3,
wherein the second determination method determines a value corresponding to an average of the extracted focus detection results or a value corresponding to a median in the range in the depth direction as the target parameter.

7. The information processing device according to claim 3,
wherein the acquisition of the information relating to the distribution of the subject areas by the first acquisition unit and the acquisition of the focus detection results of the plurality of focus detection areas by the second acquisition unit are performed intermittently,
the inference unit infers the range in the depth direction for each acquisition timing based on the intermittently acquired information relating to the distribution of the subject areas and the intermittently acquired focus detection results of the plurality of focus detection areas,
the computer program further causes the at least one processor and/or circuit to function as a judging unit configured to judge whether or not a temporal variation that exceeds a predetermined width is occurring in each of a first focus position corresponding to the nearest end of the range in the depth direction and a second focus position corresponding to the farthest end of the range in the depth direction, and
if it is judged that a temporal variation that exceeds the predetermined width is not occurring in either of the first and second focus positions, the determination unit determines the target parameter using the first determination method, and if it is judged that a temporal variation that exceeds a predetermined width is occurring in at least one of the first focus position and the second focus position, the determination unit determines the target parameter using the second determination method.

8. The information processing device according to claim 7,
wherein in the second determination method,
if a width of a temporal variation in the first focus position is greater than a width of a temporal variation in the second focus position, a value offset from a value corresponding to the farthest end among the extracted focus detection results to a near side is determined as the target parameter, and
if the width of the temporal variation in the second focus position is greater than the width of the temporal variation in the first focus position, a value offset from the value corresponding to the nearest end among the extracted focus detection results to a far side is determined as the target parameter.

9. The information processing device according to claim 2,
wherein the acquisition of the information relating to the distribution of the subject areas by the first acquisition unit and the acquisition of the focus detection results of the plurality of focus detection areas by the second acquisition unit are performed intermittently,
the inference unit infers the range in the depth direction for each acquisition timing based on the intermittently acquired information relating to the distribution of the subject areas and the intermittently acquired focus detection results of the plurality of focus detection areas, and
the determination unit determines a value determined at the last acquisition timing as the target parameter if a width of the range in the depth direction is greater than a first threshold value, and determines a value corresponding to the nearest end among the extracted focus detection results as the target parameter if the width of the range in the depth direction is less than the first threshold value.

10. The information processing device according to claim 1,
wherein the target parameter is a defocus amount,
the focus detection results of the plurality of focus detection areas are defocus amounts of the respective focus detection areas, and
the inference unit infers a range of defocus amounts as the range in the depth direction.

11. The information processing device according to claim 1,
wherein the computer program further causes the at least one processor and/or circuit to function as a third acquisition unit configured to acquire captured image signals in the captured image view angle,
the first acquisition unit acquires the information relating to the distribution of the subject areas based on the image signals acquired by the third acquisition unit, and
the second acquisition unit acquires the focus detection results of the plurality of focus detection areas based on the image signals acquired by the third acquisition unit.

12. The information processing device according to claim 11,
wherein the information relating to the distribution of the subject areas contains information on positions and sizes of areas for each predetermined part of the subject within the captured image view angle.

13. The information processing device according to claim 1,
wherein the inference unit is an inference model obtained by machine learning a range in the depth direction where each of parts of an object of the same type as the subject actually exists, using a distribution of areas corresponding to the parts of the object within the captured image view angle and a distribution of focus detection results of the areas as inputs.

14. An image capturing apparatus comprising:
an imaging optical system including a focus lens;
an image capturing unit;
a control unit configured to control the imaging optical system; and
the information processing apparatus according to claim 1,
wherein the control unit drives the focus lens based on the target parameter determined by the determination unit, and
the image capturing unit shoots an image for recording on the condition that the focus lens is driven based on the target parameter.

15. A control method of an information processing apparatus determining a target parameter for use in focus adjustment when shooting a subject, the method comprising:
acquiring information relating to a distribution of subject areas in a captured image view angle;
acquiring focus detection results of a plurality of focus detection areas provided for the captured image view angle;
inferring a range in a depth direction in which the subject exists, based on the information relating to the distribution of the subject areas and the focus detection results of the plurality of focus detection areas; and
determining the target parameter based on the inference range in the depth direction,
wherein in the determining, a method of determining the target parameter is switched according to the range in the depth direction.

16. A computer-readable recording medium having recorded thereon a program for causing a computer to function as the units of the information processing apparatus according to any one of claim 1.
